(19) United States
(12) Patent Application Publication
(10) Pub. No.: US 2026/0230873 A1
(43) Pub. Date: Aug. 6, 2026

(54) CROSS-LINK INTERFERENCE MEASUREMENT AND COMMUNICATION SCHEDULING FOR SUB-BAND FULL-DUPLEX OPERATION

(71) Applicant: QUALCOMM Incorporated, San Diego, CA (US)

(72) Inventors: Prashant SHARMA, San Marcos, CA (US); Qian ZHANG, Basking Ridge, NJ (US); Jae Ho RYU, San Diego, CA (US); Muhammad Sayed Khairy ABDELGHAFFAR, San Jose, CA (US)

(21) Appl. No.: 19/462,946

(22) Filed: Jan. 28, 2026

Related U.S. Application Data
(60) Provisional application No. 63/754,944, filed on Feb. 6, 2025.

(51) Int. Cl. H04W 24/08; H04L 5/14; H04W 74/0808

(52) U.S. Cl. CPC H04W 24/08; H04L 5/14; H04W 74/0808

(57) ABSTRACT

Various aspects of the present disclosure generally relate to wireless communication. Various aspects relate to concurrent scheduling of a plurality of different cross-link interference (CLI) measurements in a common resource. In some aspects, a network node may indicate that a user equipment (UE) is to perform a CLI reference signal received power (RSRP) measurement (in an uplink sub-band) concurrent with performing a received signal strength indicator (RSSI) measurement in a downlink sub-band or with performing an RSSI measurement in the uplink sub-band. In some aspects, when a collision occurs between scheduling of a plurality of CLI measurements, the UE may use a rule to resolve which one or more CLI measurements, of the plurality of CLI measurements, to perform. In some examples, the described techniques can be used to reduce or compensate for interference in sub-band full-duplex (SBFD) operation.

### CROSS-REFERENCE TO RELATED APPLICATION

This Patent Application claims priority to U.S. Provisional Patent Application No. 63/754,944, filed on February 6, 2025, entitled “CROSS-LINK INTERFERENCE MEASUREMENT AND COMMUNICATION SCHEDULING FOR SUB-BAND FULL-DUPLEX OPERATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with cross link interference (CLI) measurement and communication scheduling for sub-band full duplex (SBFD) operation.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A radio access network (RAN) may support communications between user equipments (UEs) and network nodes (such as gNBs, distributed units, radio units, or the like). Communications from a UE to a network node may be referred to as uplink communications, and communications from a network node to a UE may be referred to as downlink communications. Uplink communications may occur on an uplink, and downlink communications may occur on a downlink. The downlink, or a downlink communication on the downlink, may be referred to as having or being associated with one link direction (for example, a first link direction). The uplink, or an uplink communication on the uplink, may be referred to as having or being associated with another link direction (for example, a second link direction). As used herein, “first link direction” and “second link direction” refer to different link directions, and not necessarily to specific link directions. For example, as used herein, a first link direction may be one of the downlink or the uplink, and a second link direction may be the other of the downlink or the uplink.

Some UEs or network nodes may support communication in only one link direction at a given time, which is referred to as half-duplex communication. A UE that supports or is capable of only half-duplex communication may be referred to as a half-duplex UE. Other UEs or network nodes may support concurrent communication in two or more link directions, which is referred to as full duplex communication. One type of full duplex communication is sub-band full-duplex (SBFD) communication, in which a communication bandwidth of a UE or a network node is divided into one or more downlink sub-bands (or more generally, sub-bands having a first link direction) and one or more uplink sub-bands (or more generally, sub-bands having a second link direction different than the first link direction).

SBFD communication can be supported at a network node, a UE, or both. A UE that can interpret signaling relating to SBFD communication (such as signaling that configures particular sub-bands or particular time resources to be SBFD resources in which SBFD communication is supported), and that is not capable of performing or not configured to perform SBFD communication, may be referred to as an SBFD aware UE. A UE that can interpret signaling related to SBFD communication, and that is capable of performing or configured to perform SBFD communication, may be referred to as an SBFD capable UE.

### SUMMARY

Some aspects described herein relate to a method of wireless communication by a user equipment (UE). The method may include receiving configuration information associated with a set of cross-link interference (CLI) measurements in a set of resources, wherein the set of resources includes a first resource for a first measurement of the set of CLI measurements and a second resource for a second measurement of the set of CLI measurements. The method may include performing at least one measurement, of the set of CLI measurements, in accordance with a selection criterion for the set of CLI measurements.

Some aspects described herein relate to a method of wireless communication performed by a network node. The method may include transmitting configuration information associated with a set of CLI measurements in a set of resources, wherein the set of resources includes a first resource for a first measurement of the set of CLI measurements and a second resource for a second measurement of the set of CLI measurements. The method may include receiving a measurement report of at least one measurement, of the set of CLI measurements, in accordance with a selection criterion for the set of CLI measurements.

Some aspects described herein relate to a UE. The UE may include a processing system. The processing system may include one or more processors and one or more code-storing memories coupled with the one or more processors. The processing system may be configured to cause the UE to receive configuration information associated with a set of CLI measurements in a set of resources, wherein the set of resources includes a first resource for a first measurement of the set of CLI measurements and a second resource for a second measurement of the set of CLI measurements. The processing system may be configured to cause the UE to perform at least one measurement, of the set of CLI measurements, in accordance with a selection criterion for the set of CLI measurements.

Some aspects described herein relate to a network node. The network node may include a processing system. The processing system may include one or more processors and one or more code-storing memories coupled with the one or more processors. The processing system may be configured to cause the network node to transmit configuration information associated with a set of CLI measurements in a set of resources, wherein the set of resources includes a first resource for a first measurement of the set of CLI measurements and a second resource for a second measurement of the set of CLI measurements. The processing system may be configured to cause the network node to receive a measurement report of at least one measurement, of the set of CLI measurements, in accordance with a selection criterion for the set of CLI measurements.

Some aspects described herein relate to a non-transitory computer-readable medium that stores a set of instructions for wireless communication by a UE. The set of instructions, when executed by one or more processors of the UE, may cause the UE to receive configuration information associated with a set of CLI measurements in a set of resources, wherein the set of resources includes a first resource for a first measurement of the set of CLI measurements and a second resource for a second measurement of the set of CLI measurements. The set of instructions, when executed by one or more processors of the UE, may cause the UE to perform at least one measurement, of the set of CLI measurements, in accordance with a selection criterion for the set of CLI measurements.

Some aspects described herein relate to a non-transitory computer-readable medium that stores a set of instructions for wireless communication by a network node. The set of instructions, when executed by one or more processors of the network node, may cause the network node to transmit configuration information associated with a set of CLI measurements in a set of resources, wherein the set of resources includes a first resource for a first measurement of the set of CLI measurements and a second resource for a second measurement of the set of CLI measurements. The set of instructions, when executed by one or more processors of the network node, may cause the network node to receive a measurement report of at least one measurement, of the set of CLI measurements, in accordance with a selection criterion for the set of CLI measurements.

Some aspects described herein relate to an apparatus for wireless communication. The apparatus may include means for receiving configuration information associated with a set of CLI measurements in a set of resources, wherein the set of resources includes a first resource for a first measurement of the set of CLI measurements and a second resource for a second measurement of the set of CLI measurements. The apparatus may include means for performing at least one measurement, of the set of CLI measurements, in accordance with a selection criterion for the set of CLI measurements.

Some aspects described herein relate to an apparatus for wireless communication. The apparatus may include means for transmitting configuration information associated with a set of CLI measurements in a set of resources, wherein the set of resources includes a first resource for a first measurement of the set of CLI measurements and a second resource for a second measurement of the set of CLI measurements. The apparatus may include means for receiving a measurement report of at least one measurement, of the set of CLI measurements, in accordance with a selection criterion for the set of CLI measurements.

Some aspects described herein relate to a UE. The UE may include one or more and a processing system. The processing system may include one or more processors and one or more memories that store code and are coupled with the one or more processors. The processing system may be configured to cause the UE to wirelessly receive configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The processing system may be configured to cause the UE to wirelessly perform one of the first measurement or the second measurement, in a symbol, in accordance with a collision handling rule, where whether reception of data in the symbol, concurrent with the first measurement or the second measurement, occurs is in accordance with a UE capability.

Some aspects described herein relate to a network node. The network node may include one or more antennas and a processing system. The processing system may include one or more processors and one or more memories that store code and are coupled with the one or more processors. The processing system may be configured to cause the network node to wirelessly transmit configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The processing system may be configured to cause the network node to wirelessly receive a measurement report of the first measurement or the second measurement, in a symbol, in accordance with a collision handling rule, where whether transmission of data in the symbol, concurrent with the first measurement or the second measurement, occurs is in accordance with a UE capability.

Some aspects described herein relate to a method of wireless communication performed by a UE. The method may include wirelessly receiving configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The method may include wirelessly performing one of the first measurement or the second measurement, in a symbol, in accordance with a collision handling rule, where whether reception of data in the symbol, concurrent with the first measurement or the second measurement, occurs is in accordance with a UE capability..

Some aspects described herein relate to a method of wireless communication performed by a network node. The method may include wirelessly transmitting configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The method may include wirelessly receiving a measurement report of the first measurement or the second measurement, in a symbol, in accordance with a collision handling rule, where whether transmission of data in the symbol, concurrent with the first measurement or the second measurement, occurs is in accordance with a UE capability.

Some aspects described herein relate to a non-transitory computer-readable medium that stores a set of instructions for wireless communication by a UE. The set of instructions, when executed by one or more processors of the UE, may cause the UE to wirelessly receive configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The set of instructions, when executed by one or more processors of the UE, may cause the UE to wirelessly perform one of the first measurement or the second measurement, in a symbol, in accordance with a collision handling rule, where whether reception of data in the symbol, concurrent with the first measurement or the second measurement, occurs is in accordance with a UE capability..

Some aspects described herein relate to a non-transitory computer-readable medium that stores a set of instructions for wireless communication by a network node. The set of instructions, when executed by one or more processors of the network node, may cause the network node to wirelessly transmit configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The set of instructions, when executed by one or more processors of the network node, may cause the network node to wirelessly receive a measurement report of the first measurement or the second measurement, in a symbol, in accordance with a collision handling rule, where whether transmission of data in the symbol, concurrent with the first measurement or the second measurement, occurs is in accordance with a UE capability.

Some aspects described herein relate to an apparatus for wireless communication. The apparatus may include means for wirelessly receiving configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The apparatus may include means for wirelessly performing one of the first measurement or the second measurement, in a symbol, in accordance with a collision handling rule, where whether reception of data in the symbol, concurrent with the first measurement or the second measurement, occurs is in accordance with a UE capability..

Some aspects described herein relate to an apparatus for wireless communication. The apparatus may include means for wirelessly transmitting configuration information associated with a set of CLI measurements in a set of SBFD resources, where a first measurement, of the set of CLI measurements, is in a first resource in a slot in an uplink sub-band, and a second measurement, of the set of CLI measurements, is in the same resource in a downlink sub-band. The apparatus may include means for wirelessly receiving a measurement report of the first measurement or the second measurement, in a symbol, in accordance with a collision handling rule, where whether transmission of data in the symbol, concurrent with the first measurement or the second measurement, occurs is in accordance with a UE capability.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating examples of full-duplex communication in a wireless network.

FIG. 4 is a diagram illustrating examples relating to user equipment (UE) to UE cross-link interference (CLI).

FIGS. 5A and 5B are diagrams illustrating an example of CLI measurement in sub-band full-duplex (SBFD) operation.

FIGS. 6A and 6B is a diagram illustrating an example associated with CLI measurement and communication scheduling for SBFD operation.

FIG. 7 is a flowchart illustrating an example process performed, for example, at a UE or an apparatus of a UE that supports CLI measurement and communication scheduling for SBFD operation.

FIG. 8 is a flowchart illustrating an example process performed, for example, at a network node or an apparatus of a network node that supports CLI measurement and communication scheduling for SBFD operation.

FIG. 9 is a diagram of an example apparatus for wireless communication that supports CLI measurement and communication scheduling for SBFD operation.

FIG. 10 is a diagram of an example apparatus for wireless communication that supports CLI measurement and communication scheduling for SBFD operation.

FIG. 11 is a flowchart illustrating an example process performed, for example, at a UE or an apparatus of a UE that supports CLI measurement and communication scheduling for SBFD operation.

FIG. 12 is a flowchart illustrating an example process performed, for example, at a network node or an apparatus of a network node that supports CLI measurement and communication scheduling for SBFD operation.

### DETAILED DESCRIPTION

In time division duplexing (TDD), allocation of a limited set of resources for uplink may result in issues relating to coverage, latency, or capacity among other examples. To improve coverage, latency, or capacity, among other examples, a network node may schedule sub-band non-overlapping full-duplex resources in a TDD band. In a sub-band full-duplex (SBFD) symbol pattern, a carrier bandwidth may be divided, such that a first portion of the carrier bandwidth is allocated to downlink communication and a second portion of the carrier bandwidth is allocated to uplink communication (with a guard band disposed in frequency resources separating the first portion and the second portion of the carrier bandwidth).

When a plurality of user equipment (UEs) are communicating in a common area, a first UE may experience interference as a result of communications associated with a second UE. For example, the second UE may transmit one or more communications, which may interfere with transmissions to or from the first UE. Additionally or alternatively, a network node may transmit one or more communications to the second UE, which may interfere with one or more communications between the first UE and another network node. A UE may perform a cross-link interference (CLI) measurement to determine an interference characteristic of a link and adjust a communication configuration to reduce a likelihood of communication interruptions relating to interference. For example, in a first scenario, a first UE may measure a received signal strength indicator (RSSI) in a downlink sub-band. In a second scenario, the first UE may measure a reference signal received power (RSRP) of a second UE in an uplink sub-band. In a third scenario, the first UE may measure the RSSI in an uplink sub-band.

The first UE may use a configured measurement resource, of a resource set configuration, to perform one or more measurements associated with the aforementioned three scenarios, among other examples. However, some UEs may not be configured to operate in different measurement scenarios concurrently, such as in the same orthogonal frequency division multiplexing (OFDM) symbol. For example, the first UE may not perform an RSSI measurement in a downlink sub-band concurrent with performing an RSSI measurement in the uplink sub-band. However, concurrent performance of a plurality of CLI measurements may improve CLI compensation and avoidance, thereby reducing a likelihood of communication interruption.

Various aspects relate generally to CLI measurement and communication scheduling for SBFD operation. Some aspects more specifically relate to concurrent scheduling of a plurality of different CLI measurements in a common resource. In some aspects, a network node may indicate, for an OFDM symbol, that a UE is to perform a CLI RSRP measurement (in an uplink sub-band) concurrent with performing an RSSI measurement in a downlink sub-band or with performing an RSSI measurement in the uplink sub-band. In some aspects, a network node may schedule a single CLI measurement for a UE (for example, CLI measurement in an uplink sub-band or a downlink sub-band of an SBFD resource), and the UE may be scheduled with another communication operation concurrent with the single CLI measurement, such as a data reception or data transmission operation that is to occur in the same resource as the scheduled CLI measurement. In some aspects, when a collision occurs between scheduling of a plurality of CLI measurements or between a CLI measurement and another communication operation, the UE may use a rule (for example, a collision handling rule) to resolve which one or more CLI measurements, of the plurality of CLI measurements, to perform in an OFDM symbol or whether to perform the other communication operation in the OFDM symbol. In some aspects, the UE may receive configuration signaling indicating which CLI measurement scenarios to fulfill within an OFDM symbol in a static signaling message, a dynamic signaling message, or a measurement resource configuration message, among other examples. In some aspects, a UE may transmit capability signaling to identify a capability for concurrent CLI measurement and may receive an indication of one or more CLI measurements to perform in an OFDM symbol in accordance with the capability.

Particular aspects of the subject matter described in this disclosure can be implemented to realize one or more of the following potential advantages. In some examples, the described techniques can be used to schedule at least one CLI measurement in an OFDM symbol. In some examples, the described techniques can be used to reduce or compensate for interference in SBFD operation. In some examples, the described techniques can be used to reduce a likelihood of communication interruptions or dropped communications, among other examples. In some examples, by enabling the UE and network node to coordinate which measurement to perform in the presence of overlapping or colliding measurement resources, the described techniques can be used to resolve ambiguities in measurement scheduling and improve the reliability of CLI measurements. The use of a collision handling rule allows for consistent selection of measurements when resources overlap, thereby reducing the risk of conflicting operations and ensuring accurate interference characterization. By associating data transmission or reception capability with explicit UE capability signaling, the techniques described herein can support a range of device implementations and network configurations, allowing for flexible scheduling and improved resource utilization. In some aspects, the ability to indicate and utilize UE capabilities for concurrent measurement and data operations enables more efficient use of SBFD resources, supports concurrent uplink and downlink operations, and enhances network coordination. In this way, the described techniques may conserve processing resources, memory resources, and network resources by minimizing redundant measurements, reducing scheduling conflicts, and optimizing resource allocation in wireless communication systems employing SBFD and advanced CLI measurement procedures.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, or artificial intelligence or machine learning (AI/ML), among other examples.

The technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more new technologies or support one or more use cases.

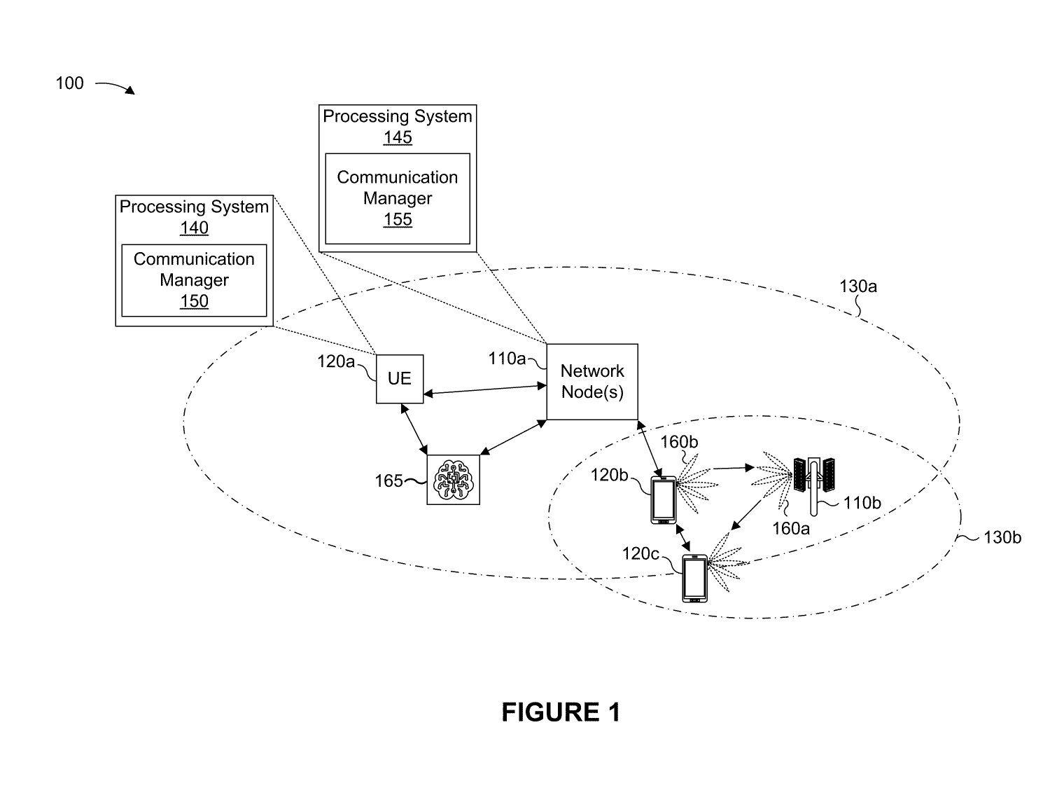

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may transmit precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive configuration information associated with a set of CLI measurements in a set of resources, wherein the set of resources includes a first resource for a first measurement of the set of CLI measurements and a second resource for a second measurement of the set of CLI measurements; and perform at least one measurement, of the set of CLI measurements, in accordance with a selection criterion for the set of CLI measurements. In some aspects, the communication manager 150 may wirelessly receive configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band; and wirelessly performing one of the first measurement or the second measurement, in a symbol, in accordance with a collision handling rule, wherein whether reception of data in the symbol, concurrent with the first measurement or the second measurement, occurs is in accordance with a UE capability. Additionally or alternatively, the communication manager 150 may perform one or more other operations described herein.

In some aspects, the network node 110 may include a communication manager 155. As described in more detail elsewhere herein, the communication manager 155 may transmit configuration information associated with a set of CLI measurements in a set of resources, wherein the set of resources includes a first resource for a first measurement of the set of CLI measurements and a second resource for a second measurement of the set of CLI measurements; and receive a measurement report of at least one measurement, of the set of CLI measurements, in accordance with a selection criterion for the set of CLI measurements. In some aspects, the communication manager 155 may wirelessly transmitting configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band; and wirelessly receiving a measurement report of the first measurement or the second measurement, in a symbol, in accordance with a collision handling rule, wherein whether transmission of data in the symbol, concurrent with the first measurement or the second measurement, occurs is in accordance with a user equipment capability. Additionally or alternatively, the communication manager 155 may perform one or more other operations described herein.

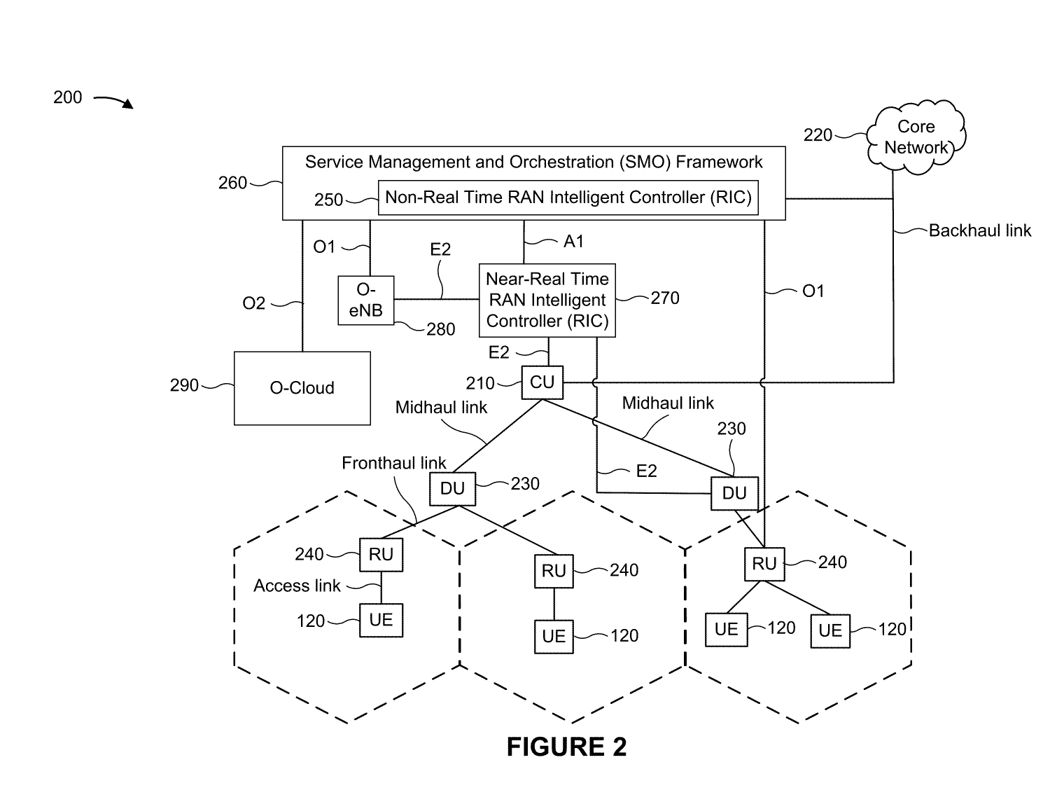

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

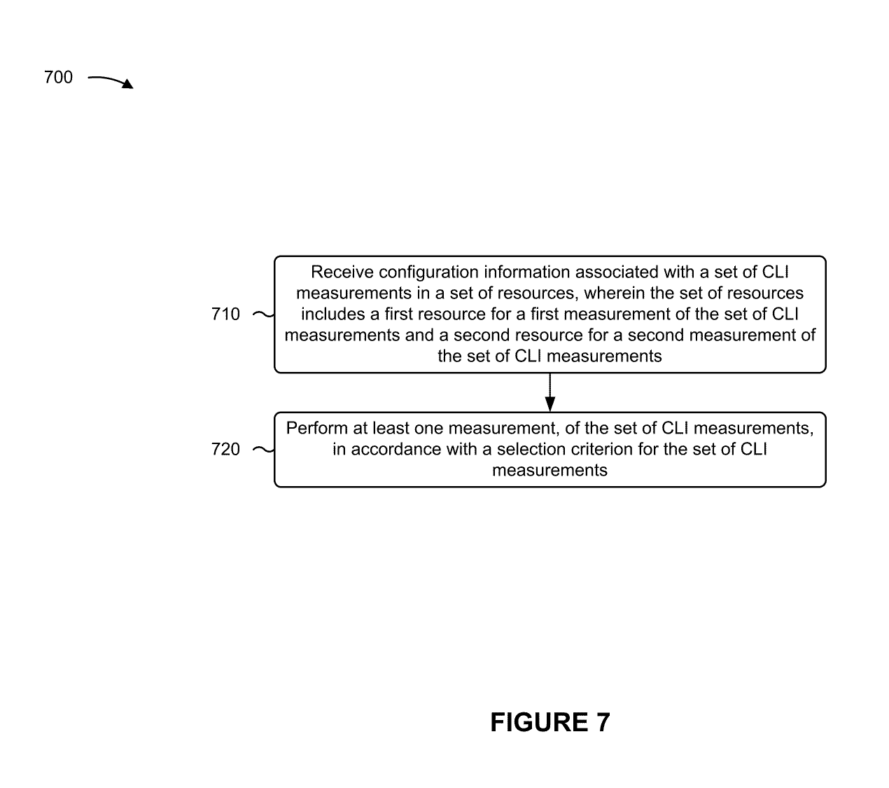

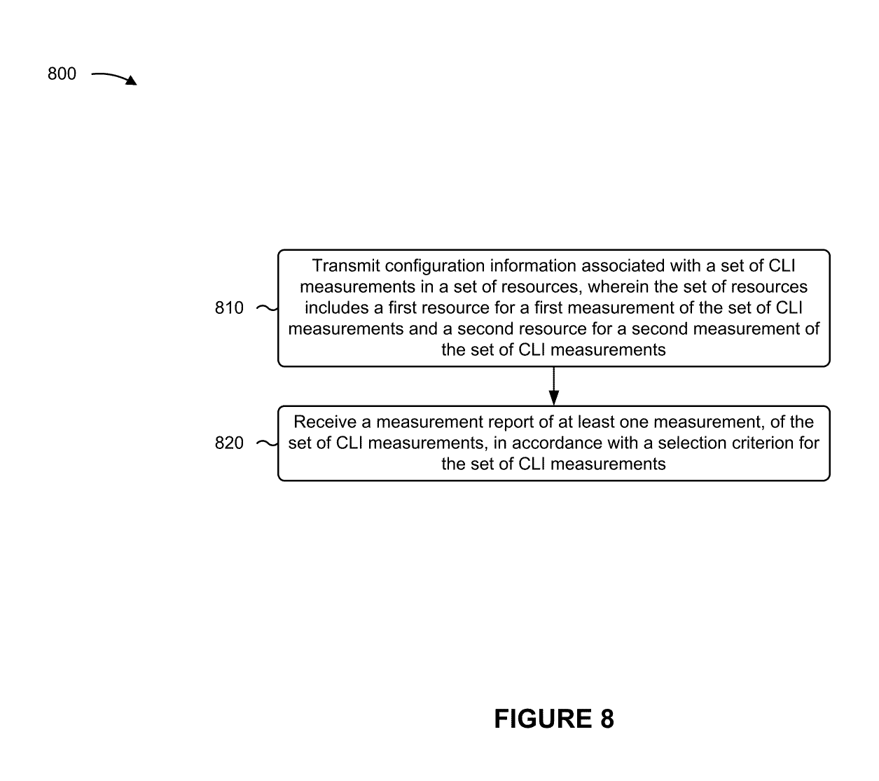

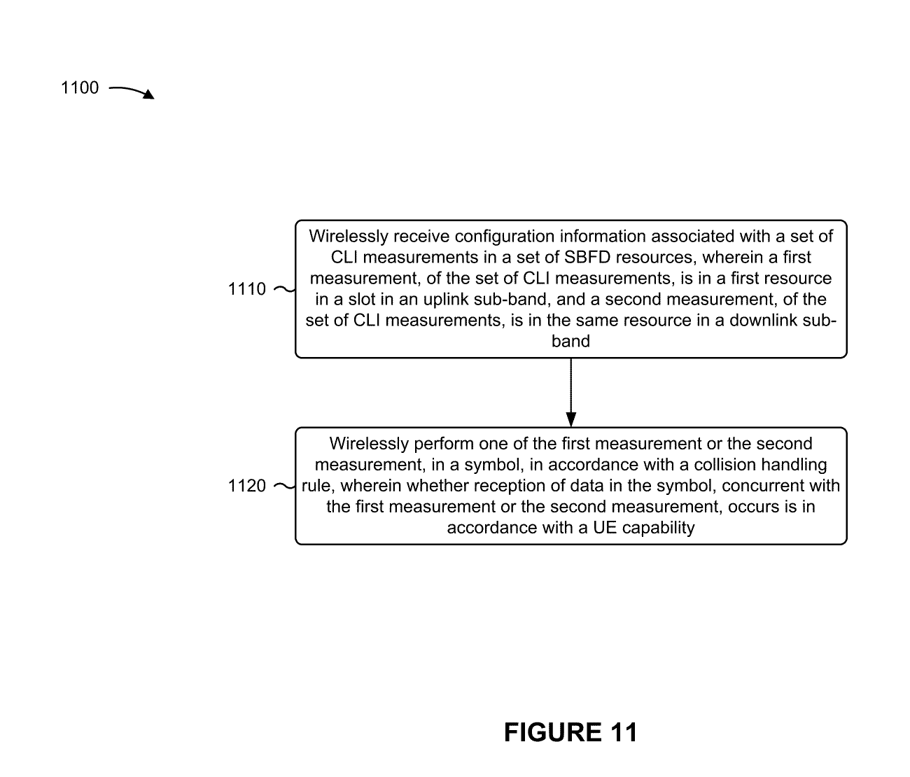

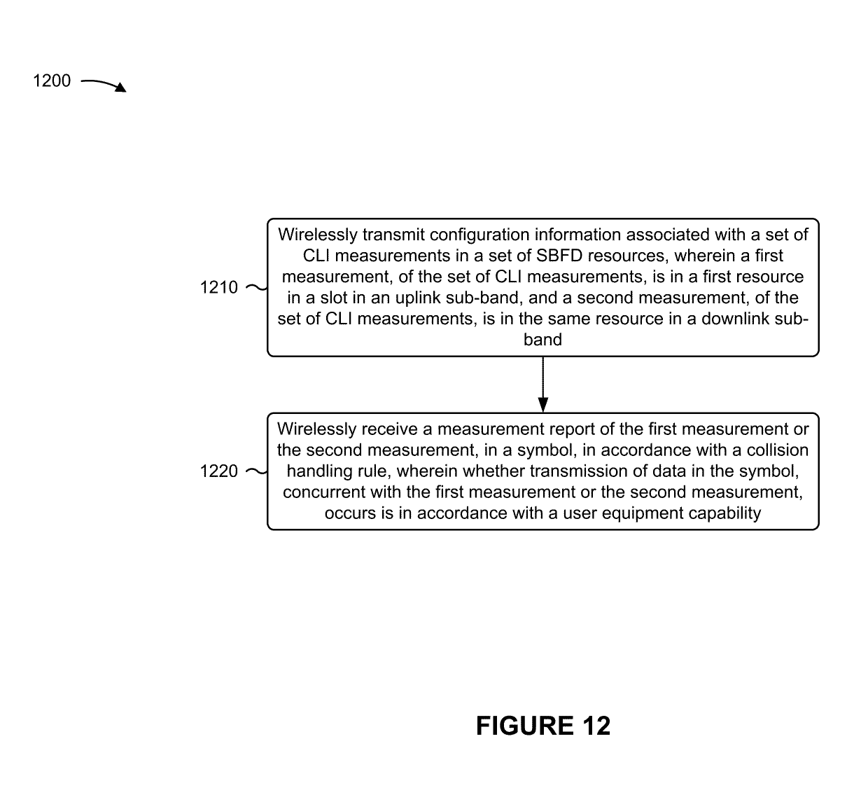

The network node 110, the processing system 145 of the network node 110, the UE 120, the processing system 140 of the UE 120, the CU 210, the DU 230, the RU 240, or any other component(s) of FIGS. 1 or FIG. 2 may implement one or more techniques or perform one or more operations associated with CLI measurement and scheduling for SBFD operation, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, process 1100 of FIG. 11, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, process 1100 of FIG. 11, process 1200 of FIG. 12, or other processes as described herein. In some examples, executing instructions may include running the instructions, converting the instructions, compiling the instructions, or interpreting the instructions, among other examples.

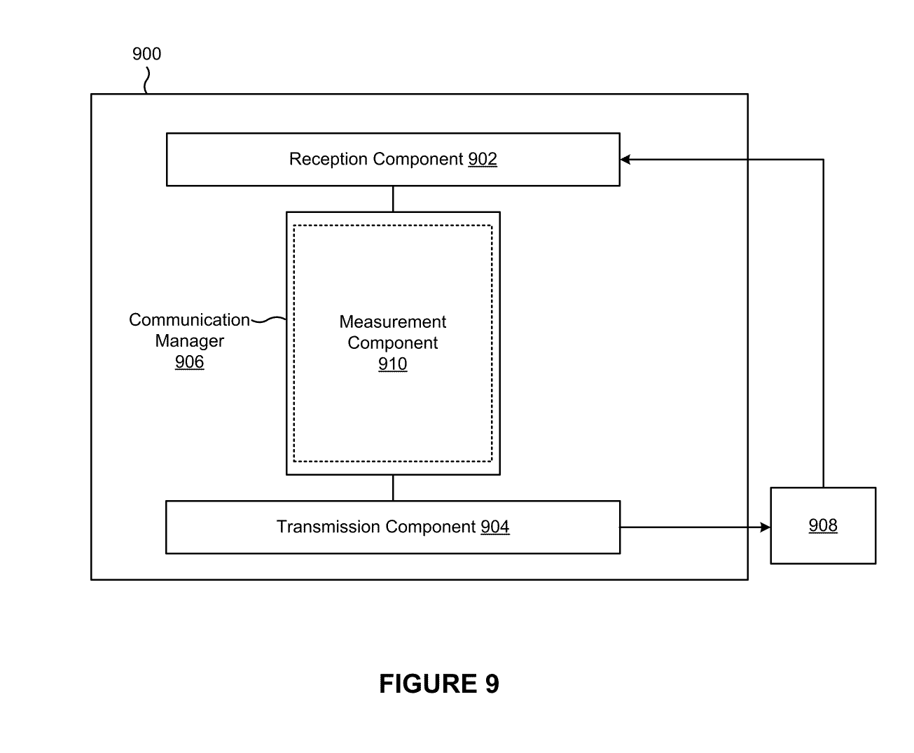

In some aspects, the UE 120 includes means for receiving configuration information associated with a set of CLI measurements in a set of resources, wherein the set of resources includes a first resource for a first measurement of the set of CLI measurements and a second resource for a second measurement of the set of CLI measurements; or means for performing at least one measurement, of the set of CLI measurements, in accordance with a selection criterion for the set of CLI measurements. In some aspects, the UE 120 includes means for wirelessly receiving configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band; or means for wirelessly performing one of the first measurement or the second measurement, in a symbol, in accordance with a collision handling rule, wherein whether reception of data in the symbol, concurrent with the first measurement or the second measurement, occurs is in accordance with a UE capability. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

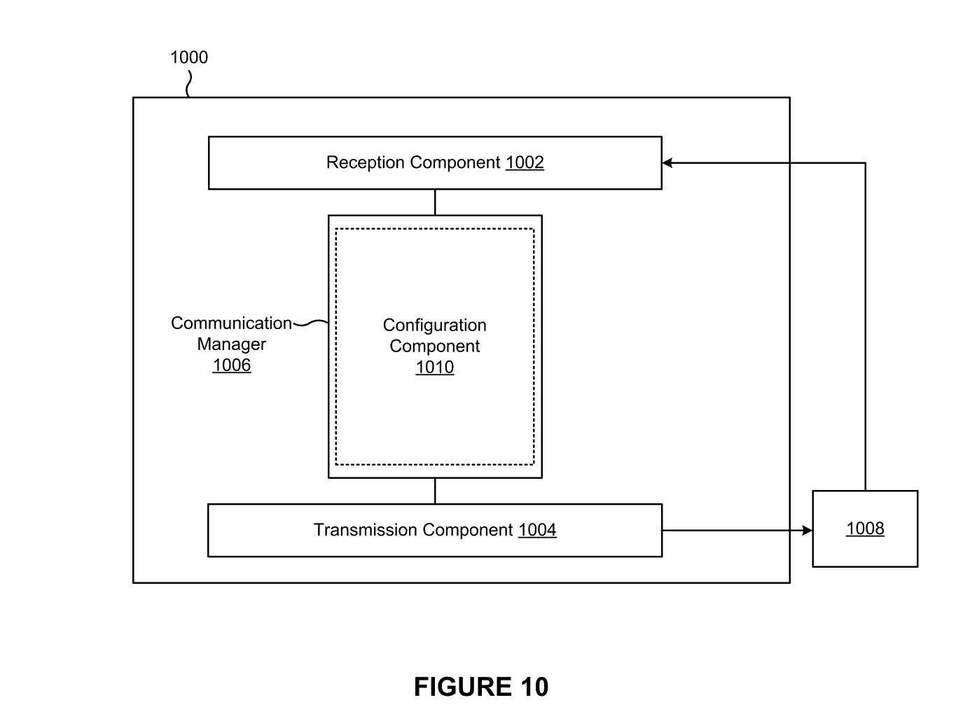

In some aspects, the network node 110 includes means for transmitting configuration information associated with a set of CLI measurements in a set of resources, wherein the set of resources includes a first resource for a first measurement of the set of CLI measurements and a second resource for a second measurement of the set of CLI measurements; or means for receiving a measurement report of at least one measurement, of the set of CLI measurements, in accordance with a selection criterion for the set of CLI measurements. In some aspects, the network node 110 includes means for wirelessly transmitting configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band; or means for wirelessly receiving a measurement report of the first measurement or the second measurement, in a symbol, in accordance with a collision handling rule, wherein whether transmission of data in the symbol, concurrent with the first measurement or the second measurement, occurs is in accordance with a user equipment capability. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

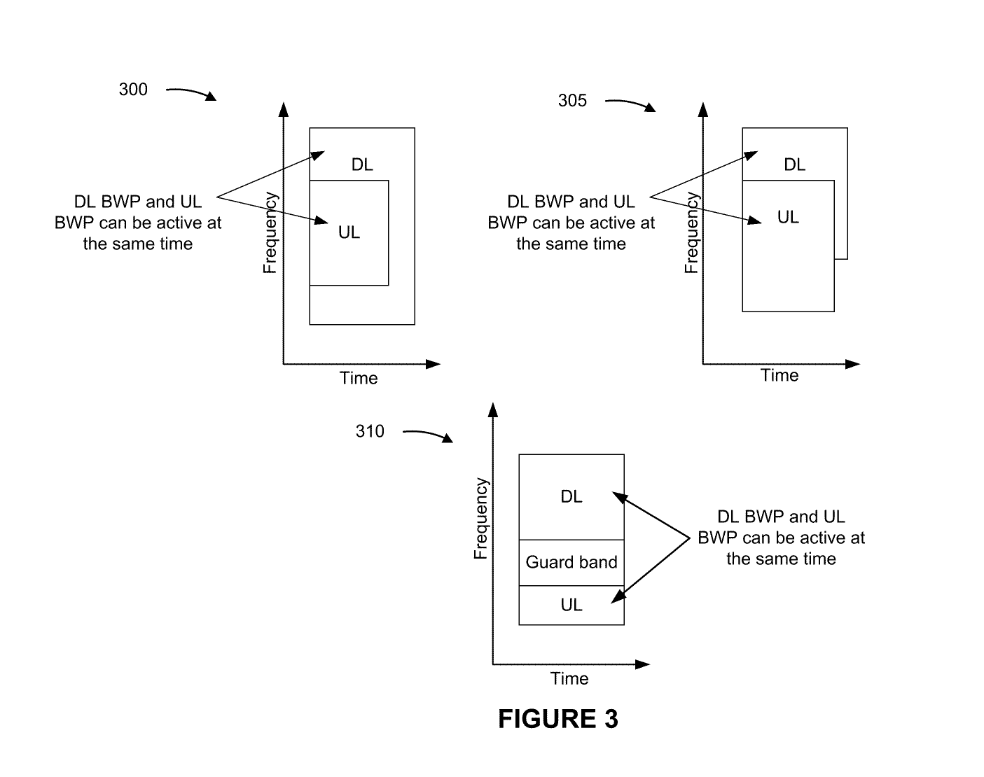

FIG. 3 is a diagram illustrating examples 300, 305, and 310 of full-duplex communication in a wireless network. “Full-duplex communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). “Half-duplex communication” in a wireless network refers to unidirectional communications (for example, only downlink communication or only uplink communication) between devices at a given time (for example, in a given slot or a given symbol).

As shown in FIG. 3, examples 300 and 305 show examples of in-band full-duplex (IBFD) communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In such examples, the frequency resources used for downlink communication may be separated from the frequency resources used for uplink communication, in the frequency domain, by a guard band.

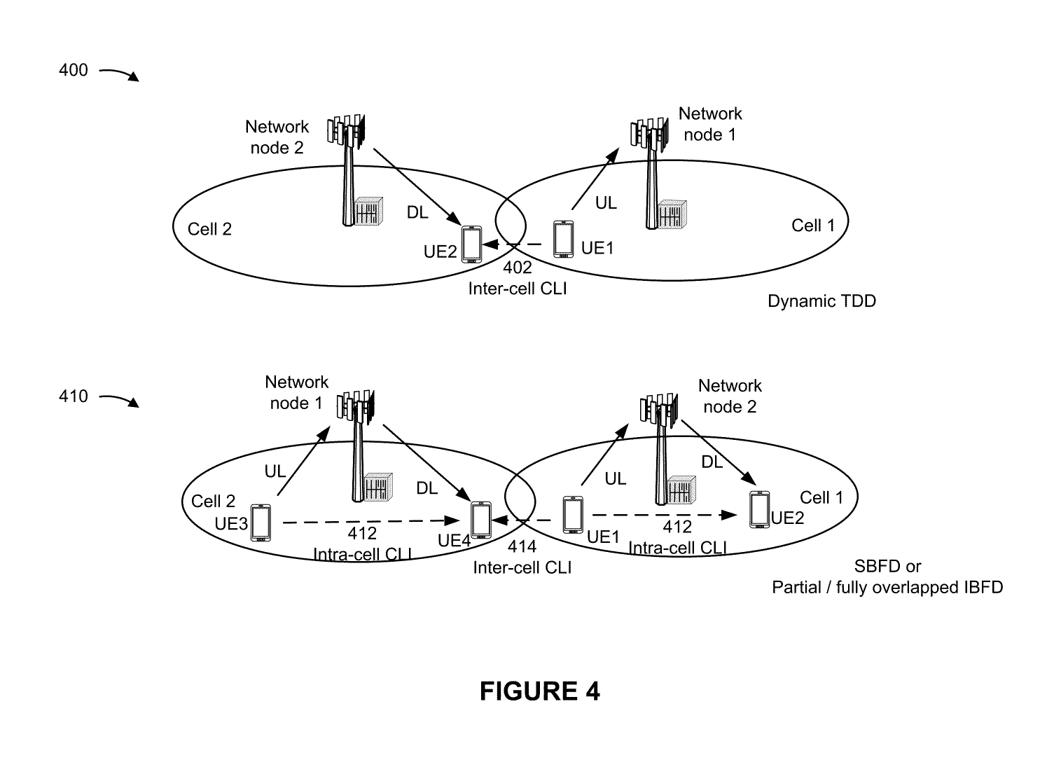

FIG. 4 is a diagram illustrating examples 400 and 410 relating to UE-to-UE CLI.

Example 400 shows an example of dynamic TDD communication. As shown in example 400, when dynamic TDD is implemented, neighboring cells (cell 1 and cell 2) may use different TDD configurations to communicate with UEs, which may result in an uplink communication between a first UE (UE1) and a first network node (network node 1) in a same transmission time interval (TTI) as a downlink communication between a second network node (network node 2) and a second UE (UE2). These communications in different transmission directions (for example, downlink versus uplink) in the same TTI may interfere with one another, which may be referred to as CLI. Interference with reception of a downlink communication by one UE caused by transmission of an uplink communication by another UE may be referred to as UE-to-UE CLI or inter-UE CLI.

For example, as shown by reference number 402, in the dynamic TDD scenario, transmission of the uplink communication in a symbol or a slot by UE1 in cell 1 may interfere with reception of the downlink communication in the symbol or the slot by UE2 in cell 2. Such interference may be referred to as inter-cell UE-to-UE CLI or inter-cell inter-UE CLI.

Example 410 shows an example of full duplex (FD) communication, such as SBFD, fully overlapping IBFD, or partial overlapping IBFD. As shown by reference number 412, in an FD scenario, transmission of an uplink communication in an SBFD or IBFD slot or symbol by one UE in a cell may interfere with reception of a downlink communication in the SBFD or IBFD slot or symbol by another UE in the cell. For example, transmission of an uplink communication in an SBFD or IBFD slot or symbol by a first UE (UE1) in a first cell (cell 1) may interfere with reception of a downlink communication in the SBFD or IBFD slot or symbol by a second UE (UE2) in cell 1. As another example, transmission of an uplink communication in an SBFD or IBFD slot or symbol by a third UE (UE3) in a second cell (cell 2) may interfere with reception of a downlink communication in the SBFD or IBFD slot or symbol by a fourth UE (UE4) in cell 2. Such interference may be referred to as intra-cell UE-to-UE CLI or intra-cell inter-UE CLI. In an SBFD scenario, transmission of an uplink communication on an uplink sub-band (SB) in an SBFD symbol or slot by one UE (for example, UE1) in a cell (for example, cell 1) may interfere with reception of a downlink communication on a downlink SB in the SBFD symbol or slot by another UE (for example, UE2) in the cell. Such interference may be referred to as inter-SB intra-cell UE-to-UE CLI or inter-SB intra-cell inter-UE CLI.

As shown by reference number 414, in an FD scenario, transmission of an uplink communication in an SBFD or an IBFD symbol or slot by UE1 in cell 1 may interfere with reception of a downlink communication in the SBFD of IBFD symbol or slot by UE4 in cell 2. Such interference may be referred to as inter-cell inter-UE CLI. In an SBFD scenario, transmission of an uplink communication on an uplink SB in an SBFD symbol or slot by UE1 in cell 1 may interfere with reception of a downlink communication on a downlink SB in the SBFD symbol or slot by UE4 in cell 2. Such interference may be referred to as inter-SB inter-cell inter-UE CLI.

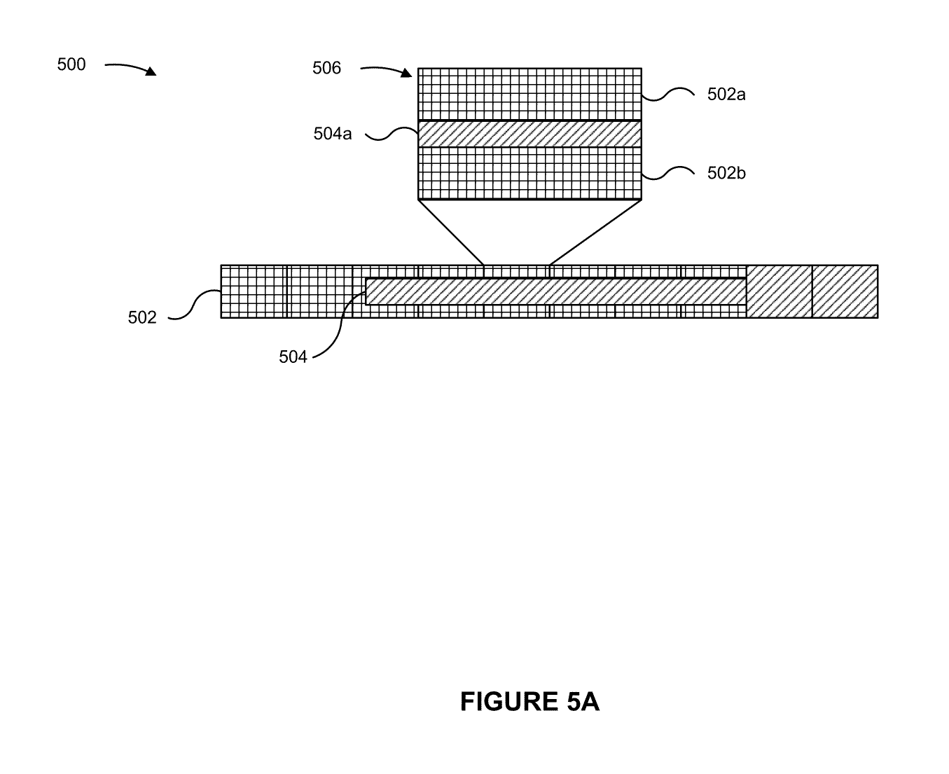

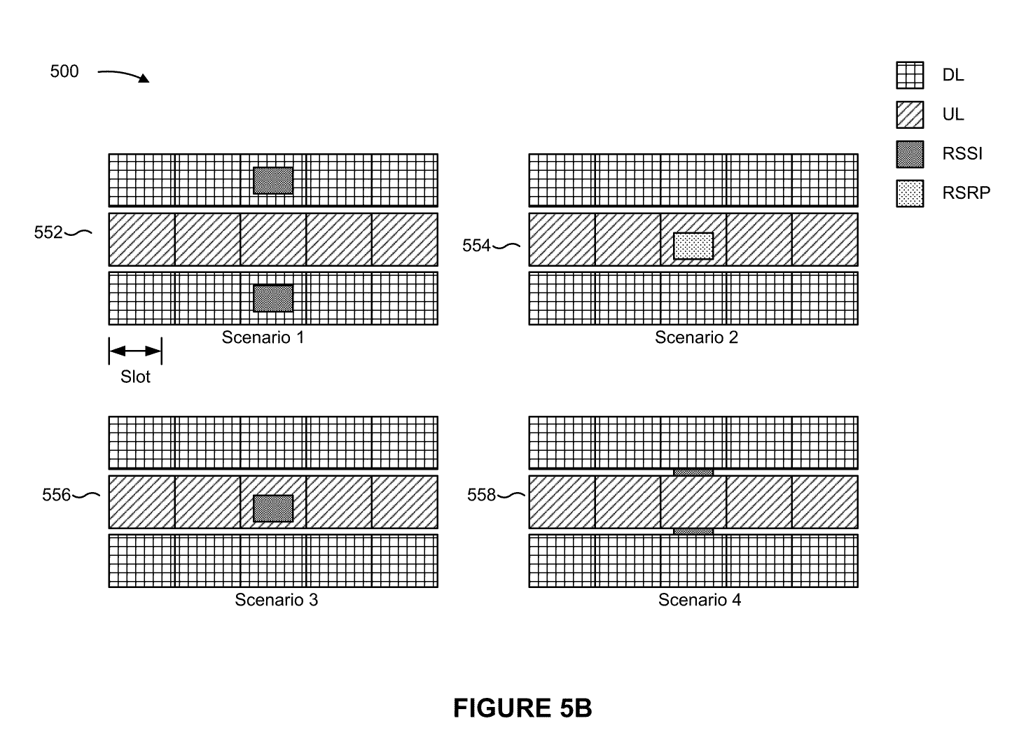

FIGS. 5A and 5B are diagrams illustrating an example 500 of CLI measurement in SBFD operation.

As shown in FIG. 5A, a resource allocation for a UE may include a set of downlink symbols 502 and a set of uplink symbols 504. In an SBFD mode, an OFDM symbol 506 includes both a downlink portion, such as the downlink symbols 502a and 502b, and an uplink portion, such as uplink symbols 504a. Although some aspects are described in terms of uplink and downlink, it is contemplated that an SBFD mode may be used with another configuration of a first direction link and a second direction link, such as a configuration that includes a sidelink or a backhaul link, among other examples.

As shown in FIG. 5B, a UE may be configured for different measurement scenarios. As shown by reference number 552, in a first measurement scenario, the UE may be configured to perform a CLI RSSI measurement in an OFDM symbol in downlink (DL) sub-bands. As shown by reference number 554, in a second measurement scenario, the UE may be configured to perform a CLI RSRP measurement in an OFDM symbol in an uplink (UL) sub-band. As shown by reference number 556, in a third measurement scenario, the UE may be configured to perform a CLI RSSI measurement in an OFDM symbol in an uplink sub-band. As shown by reference number 558, in a fourth measurement scenario, the UE may be configured to perform a CLI RSSI measurement in an OFDM symbol in a guard band (which is disposed between the downlink sub-bands and the uplink sub-band).

As indicated above, FIGS. 5A and 5B are provided as an example. Other examples may differ from what is described with respect to FIGS. 5A and 5B.

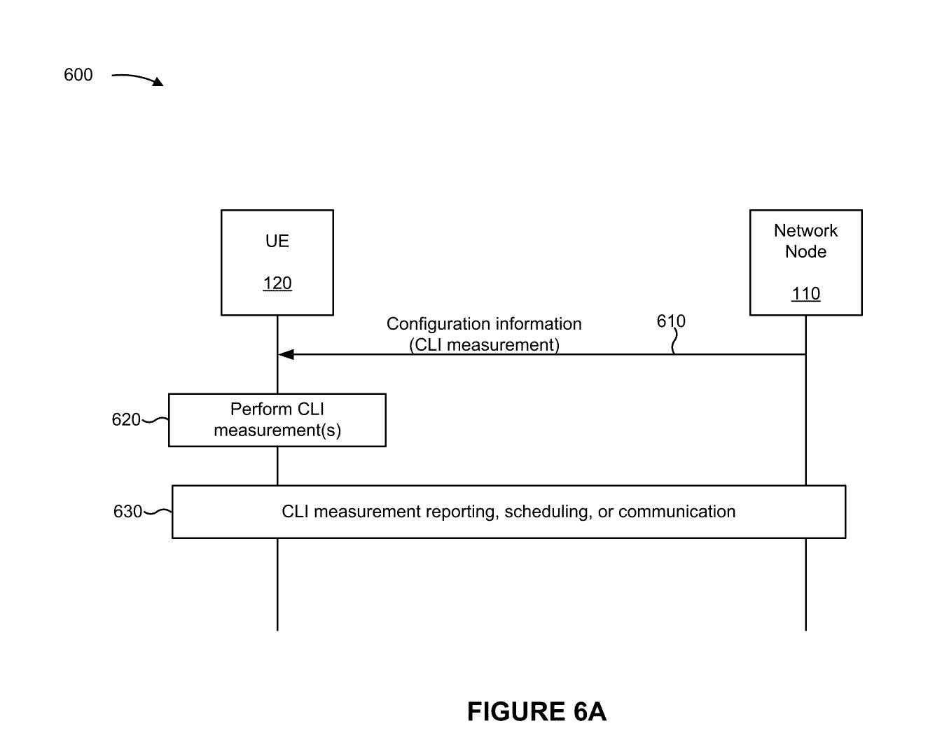

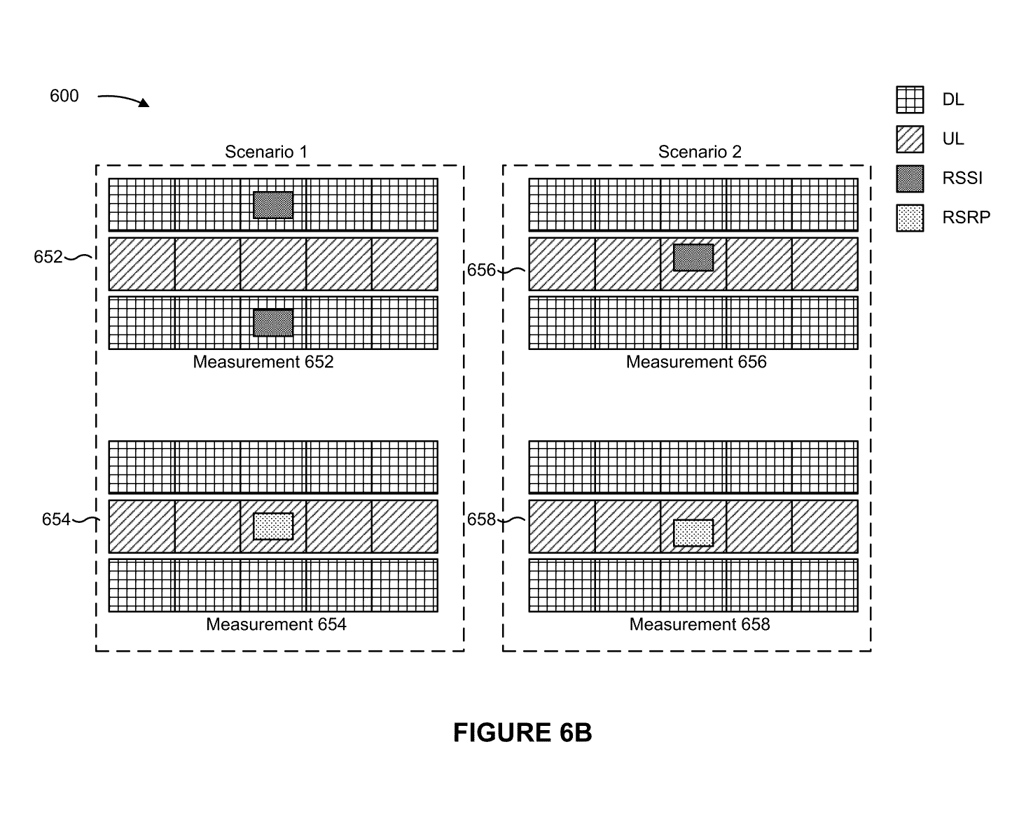

FIGS. 6A and 6B is a diagram illustrating an example 600 associated with CLI measurement and communication scheduling for SBFD operation. As shown in FIG. 6A, example 600 includes communication between a network node 110 and a UE 120.

As further shown in FIG. 6A, and by reference number 610, the UE 120 may receive configuration information. For example, the UE 120 may receive, from the network node 110, information associated with configuring CLI measurement. Additionally or alternatively, the UE 120 may receive configuration information scheduling one or more CLI measurements, such as a plurality of concurrent CLI measurements. For example, the configuration information may schedule a set of CLI measurements, such as a first CLI measurement in an uplink sub-band or a second CLI measurement in a downlink sub-band, or a combination thereof. In some aspects, the UE 120 may receive the configuration information wirelessly (for example, via a wireless link).

In some aspects, the UE 120 may receive configuration information indicating a particular set of CLI measurements that the UE 120 is to perform. For example, as shown in FIG. 6B, the UE 120 may receive configuration information indicating that the UE 120 is scheduled to perform measurement 652, which includes RSSI measurements in downlink resources, such as a downlink sub-band of a set of SBFD resources. Additionally, or alternatively, the UE 120 may receive a configuration indicating that the UE 120 is scheduled to perform measurement 654, which includes RSRP measurements in uplink resources, such as an uplink sub-band of a set of SBFD resources. Similarly, the UE 120 may receive configuration information scheduling the UE 120 to perform measurement 656, which includes RSSI measurements in uplink resources, or measurement 658, which includes RSRP measurements in uplink resources. In some aspects, the UE 120 may be scheduled with a collision between measurements or other communication operations. For example, the UE 120 may be scheduled to perform measurement 652 and measurement 654 concurrently in a first scenario. Additionally or alternatively, the UE 120 may be scheduled to perform measurement 656 and measurement 658 concurrently in a second scenario. Additionally, or alternatively, the UE 120 may be scheduled to perform a measurement, such as measurements 652-658, concurrent with reception of data from a network node 110 or transmission of data to the network node 110. In other words, the UE 120 may receive configuration information scheduling a CLI measurement in a resource that the UE 120 could otherwise use to receive or transmit separate from the CLI measurement.

In some aspects, the UE 120 may receive signaling of which measurements or communication operations to perform in connection with scheduling of a plurality of concurrent measurements. In other words, the UE 120 may be scheduled in with the first scenario (measurements 652 and 654) and may receive an indication from the network node 110 of which measurement to perform (the RSSI measurements in the downlink resources or the RSRP measurements in the uplink resources). In some aspects, the UE 120 may receive the signaling of which measurements to perform via a particular type of signaling. For example, the UE 120 may receive signaling via radio resource control (RRC) signaling, downlink control information (DCI) signaling, MAC-CE signaling, or system information signaling, among other examples. Additionally or alternatively, the UE 120 may receive signaling via a measurement resource configuration message. For example, the UE 120 may receive a measurement configuration information element that includes a measurement priority field (with a value, such as a high value, a medium value, or a low value). In this example, the UE 120 prioritize between colliding (concurrent) measurements in accordance with the priority value. In some aspects, when the measurement priority field is not included or does not include a value, the UE 120 may use a default priority value for one or more measurements.

Additionally or alternatively, the UE 120 may use a static rule, such as a rule defined in a specification, to handle a collision associated with a configuration. For example, when the UE 120 is scheduled for the second scenario (measurements 656 and 658), the UE 120 may use a static prioritization rule and determine to prioritize performing the RSRP measurement in the uplink resources rather than the RSSI measurement in the uplink resources. Additionally, or alternatively, the UE 120 may use a collision handling rule. In some aspects, the rule may relate to a type of measurement. For example, the rule may indicate that RSSI measurements are to be prioritized over RSRP measurements (across the first and second scenarios). Additionally or alternatively, the rule may relate to a type of resource. For example, the rule may indicate that a measurement in downlink sub-band is to be prioritized over a measurement in the uplink sub-band (in the first scenario).

In some aspects, the UE 120 may perform a plurality of concurrent communication operations, such as measurements. For example, some UEs 120 may have a capability relating to performing a plurality of concurrent communication operations, such measurements. In some aspects, the UE 120 may transmit capability signaling, such as a UE capability indicator, identifying a capability relating to performing concurrent measurements. A UE capability can refer to a specific functional ability of UE 120 in a wireless communication system, such as the ability to receive data in a symbol concurrently with performing a cross-link interference (CLI) measurement. For example, the UE 120 may be capable of concurrently receiving a serving cell signal in a downlink sub-band while conducting a CLI measurement in an uplink sub-band, as determined by configured capabilities. Accordingly, in some aspects, the UE 120 may transmit an indication of a UE capability to the network node 110, enabling the network node 110 to schedule resources and measurements in accordance with the UE 120’s supported function.

As a particular example, the UE 120 may transmit capability information indicating that the UE 120 supports performing measurements 652 and 654, measurements 656 and 658, or a measurement (for example, a measurement 652-658) and reception of data or transmission of data, concurrently, among other examples. In such examples, based on or otherwise associated with transmitting the capability information, the UE 120 may receive configuration information scheduling the UE 120 to perform measurements 652 and 654 or measurements 656 and 658 concurrently, among other examples. In other words, rather than a static collision rule for rejecting reception of data when the UE 120 is configured to perform a CLI measurement, the UE 120 may, based on or otherwise associated with a capability of the UE 120, receive data or transmit data (as well as decode, process, or otherwise use the data) in the same symbol that the UE 120 uses to perform the CLI measurement. In this way, the UE 120 can selectively perform additional communication operations concurrent with CLI measurement.

In some aspects, the UE 120 may receive configuration information relating to a timing for one or more measurements. For example, layer 1 (L1) CLI RSSI measurements may use a downlink timing for measurements 652, but L1 CLI sounding reference signal (SRS) RSRP measurements may use an uplink timing for measurements 654. In such examples, the UE 120 may receive an indication of whether to use the downlink timing or the uplink timing for an indicated communication operation (for example, a measurement, transmission of data, or reception of data), such as the L1 CSI RSSI measurement of measurements 656. Additionally or alternatively, the UE 120 may transmit an indication of whether the uplink timing or the downlink timing is to be used. Additionally or alternatively, whether to use the uplink timing or downlink timing may be a static parameter, such as a selection specified in a specification.

In some aspects, one or more communication restrictions or rules may be associated with scheduling information or configuration information. For example, the UE 120 may be configured to refrain from transmitting a physical uplink control channel (PUCCH), a physical uplink shared channel (PUSCH), or an SRS, among other examples on OFDM symbols in which the UE 120 performs CLI measurements. Additionally or alternatively, the UE 120 may be configured to refrain from receiving a physical downlink control channel (PDCCH), a physical downlink shared channel (PDSCH), a tracking channel state information (CSI) reference signal (CSI-RS), or a channel quality indicator (CQI) CSI-RS on OFDM symbols in which the UE 120 performs CLI measurements. Accordingly, the configuration information may not schedule one or more of the aforementioned communications for the same OFDM symbol for which a CLI measurement is scheduled. If one or more of the aforementioned communications is scheduled for the same OFDM symbol for which the CLI measurement is scheduled, the UE 120 may treat such a scenario as an error case, in some aspects. Additionally or alternatively, the UE 120 may use a collision handling rule to handle such a scenario, such as by dropping the scheduled communication or dropping the CLI measurement.

Additionally or alternatively, some UEs may have a capability of performing CLI measurements and the aforementioned communications in the same OFDM symbol and may concurrently perform a plurality of communications operations. For example, the UE 120 may indicate a capability for receiving a PDCCH, PDSCH, tracking CSI-RS, or CQI CSI-RS in a downlink sub-band concurrent with performing an L1 CLI RSSI measurement of measurements 656 or measurements 652. In such examples, when the UE 120 has or indicates such a capability, the UE 120 may perform an L1 CLI RSSI measurement of measurements 656 or measurements 652 without a scheduling restriction. Similarly, the UE 120 may indicate a capability for receiving a PDCCH, PDSCH, tracking CSI-RS, or CQI CSI-RS in a downlink sub-band concurrent with performing an L1 SRS RSRP measurement of measurements 654, among other examples.

In some aspects, the UE 120 may have a guard period in connection with an OFDM symbol in which CLI measurements are scheduled. For example, the UE 120 may not transmit or receive in a particular time interval, such as one or more symbols, before or after an OFDM symbol in which CLI measurements are scheduled. In some aspects a size of the particular time interval may be based on or otherwise associated with a timing synchronization error between the UE 120 and the network node, a subcarrier spacing, or another parameter. In some aspects, the UE 120 may indicate or receive an indication of the size of the particular time interval. In some aspects, a size of the particular time interval may be a static parameter, such as a parameter that is specified in a specification.

As further shown in FIG. 6A, and by reference number 620, the UE 120 may perform one or more CLI measurements. For example, based on or otherwise associated with the configuration information identifying a measurement configuration for CLI measurement, the UE 120 may perform an RSSI measurement or an RSRP measurement, among other examples, on an uplink or a downlink, among other examples. In some aspects, the UE 120 may perform a plurality of concurrent measurements. For example, the UE 120 may perform concurrent RSSI and RSRP measurements on an uplink and a downlink, respectively, or may perform concurrent RSSI and RSRP measurements on an uplink. In some aspects, the UE 120 may perform a CLI measurement concurrent with another communication operation. For example, the UE 120 may perform a CLI measurement in an uplink or downlink sub-band of an SBFD resource in a symbol and may receive (as well as decode and process) downlink data conveyed in the same symbol. Additionally, or alternatively, the UE 120 may perform a CLI measurement in an uplink or downlink sub-band of an SBFD resource in a symbol and may transmit (as well as process and encode) uplink data for conveyance in the same symbol.

As further shown in FIG. 6A, and by reference number 630, the UE 120 may perform one or more communication operations associated with the one or more CLI measurements. For example, the UE 120 may transmit a measurement report identifying a result of performing the one or more CLI measurements. Additionally or alternatively, the UE 120 may receive scheduling information identifying a set of resources on which to a communicate in accordance with the one or more CLI measurements. Additionally or alternatively, the UE 120 may receive configuration information identifying a beam configuration that is selected in accordance with the one or more CLI measurements. Based on or otherwise associated with receiving scheduling information or configuration information, among other examples, the UE 120 may communicate on an uplink or a downlink, among other examples.

As indicated above, FIGS. 6A and 6B are provided as an example. Other examples may differ from what is described with respect to FIGS. 6A and 6B.

FIG. 7 is a flowchart illustrating an example process 700 performed, for example, at a UE or an apparatus of a UE that supports CLI measurement and communication scheduling for SBFD operation. Example process 700 is an example where the apparatus or the UE (for example, UE 120) performs operations associated with CLI measurement and communication scheduling for SBFD operation.

As shown in FIG. 7, in some aspects, process 700 may include receiving configuration information associated with a set of CLI measurements in a set of resources, wherein the set of resources includes a first resource for a first measurement of the set of CLI measurements and a second resource for a second measurement of the set of CLI measurements (block 710). For example, the UE (such as by using communication manager 150 or reception component 902, depicted in FIG. 9) may receive configuration information associated with a set of CLI measurements in a set of resources, wherein the set of resources includes a first resource for a first measurement of the set of CLI measurements and a second resource for a second measurement of the set of CLI measurements, as described above.

As further shown in FIG. 7, in some aspects, process 700 may include performing at least one measurement, of the set of CLI measurements, in accordance with a selection criterion for the set of CLI measurements (block 720). For example, the UE (such as by using communication manager 150 or measurement component 910, depicted in FIG. 9) may perform at least one measurement, of the set of CLI measurements, in accordance with a selection criterion for the set of CLI measurements, as described above.

Process 700 may include additional aspects, such as any single aspect or any combination of aspects described below or in connection with one or more other processes described elsewhere herein.

In a first additional aspect, the configuration information includes an indication of a selection of the at least one measurement of the set of CLI measurements.

In a second additional aspect, alone or in combination with the first aspect, the selection criterion includes a collision handling rule.

In a third additional aspect, alone or in combination with one or more of the first and second aspects, the selection criterion is in accordance with a stored configuration.

In a fourth additional aspect, alone or in combination with one or more of the first through third aspects, the configuration information includes an indication of a selection of the at least one measurement, and wherein the indication is applicable to a plurality of measurement opportunities.

In a fifth additional aspect, alone or in combination with one or more of the first through fourth aspects, at least a portion of the configuration information is received in connection with a measurement resource configuration message.

In a sixth additional aspect, alone or in combination with one or more of the first through fifth aspects, process 700 includes transmitting capability signaling identifying a capability for performing one or more of the set of CLI measurements, and receiving an indication of a selection of the at least one measurement of the set of CLI measurements in accordance with the capability signaling.

In a seventh additional aspect, alone or in combination with one or more of the first through sixth aspects, process 700 includes transmitting signaling indicating whether one or more of the set of CLI measurements are associated with an uplink timing or a downlink timing.

In an eighth additional aspect, alone or in combination with one or more of the first through seventh aspects, the configuration information includes an indication of a timing configuration for the at least one measurement of the set of CLI measurements.

In a ninth additional aspect, alone or in combination with one or more of the first through eighth aspects, a timing configuration for the at least one measurement of the set of CLI measurements is in accordance with a stored configuration.

In a tenth additional aspect, alone or in combination with one or more of the first through ninth aspects, a scheduling of one or more communications within a time interval of the at least one measurement of the set of CLI measurements is in accordance with a timing of the at least one measurement of the set of CLI measurements.

In an eleventh additional aspect, alone or in combination with one or more of the first through tenth aspects, process 700 includes transmitting a capability indicator relating to a duplex capability for the set of CLI measurements, and wherein a scheduling of one or more communications within a time interval of the at least one measurement of the set of CLI measurements is in accordance with the duplex capability.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports CLI measurement and communication scheduling for SBFD operation. Example process 800 is an example where the apparatus or the network node (for example, network node 110) performs operations associated with CLI measurement and communication scheduling for SBFD operation.

As shown in FIG. 8, in some aspects, process 800 may include transmitting configuration information associated with a set of CLI measurements in a set of resources, wherein the set of resources includes a first resource for a first measurement of the set of CLI measurements and a second resource for a second measurement of the set of CLI measurements (block 810). For example, the network node (such as by using communication manager 155 or transmission component 1004, depicted in FIG. 10) may transmit configuration information associated with a set of CLI measurements in a set of resources, wherein the set of resources includes a first resource for a first measurement of the set of CLI measurements and a second resource for a second measurement of the set of CLI measurements, as described above.

As further shown in FIG. 8, in some aspects, process 800 may include receiving a measurement report of at least one measurement, of the set of CLI measurements, in accordance with a selection criterion for the set of CLI measurements (block 820). For example, the network node (such as by using communication manager 155 or reception component 1002, depicted in FIG. 10) may receive a measurement report of at least one measurement, of the set of CLI measurements, in accordance with a selection criterion for the set of CLI measurements, as described above.

Process 800 may include additional aspects, such as any single aspect or any combination of aspects described below or in connection with one or more other processes described elsewhere herein.

In a first additional aspect, the configuration information includes an indication of a selection of the at least one measurement of the set of CLI measurements.

In a second additional aspect, alone or in combination with the first aspect, the selection criterion includes a collision handling rule.

In a third additional aspect, alone or in combination with one or more of the first and second aspects, the selection criterion is in accordance with a stored configuration.

In a fourth additional aspect, alone or in combination with one or more of the first through third aspects, the configuration information includes an indication of a selection of the at least one measurement, and wherein the indication is applicable to a plurality of measurement opportunities.

In a fifth additional aspect, alone or in combination with one or more of the first through fourth aspects, at least a portion of the configuration information is received in connection with a measurement resource configuration message.

In a sixth additional aspect, alone or in combination with one or more of the first through fifth aspects, process 800 includes receiving capability signaling identifying a capability for performing one or more of the set of CLI measurements, and transmitting an indication of a selection of the at least one measurement of the set of CLI measurements in accordance with the capability signaling.

In a seventh additional aspect, alone or in combination with one or more of the first through sixth aspects, process 800 includes receiving signaling indicating whether one or more of the set of CLI measurements are associated with an uplink timing or a downlink timing.

In an eighth additional aspect, alone or in combination with one or more of the first through seventh aspects, the configuration information includes an indication of a timing configuration for the at least one measurement of the set of CLI measurements.

In a ninth additional aspect, alone or in combination with one or more of the first through eighth aspects, a timing configuration for the at least one measurement of the set of CLI measurements is in accordance with a stored configuration.

In a tenth additional aspect, alone or in combination with one or more of the first through ninth aspects, a scheduling of one or more communications within a time interval of the at least one measurement of the set of CLI measurements is in accordance with a timing of the at least one measurement of the set of CLI measurements.

In an eleventh additional aspect, alone or in combination with one or more of the first through tenth aspects, process 800 includes receiving a capability indicator relating to a duplex capability for the set of CLI measurements, and wherein a scheduling of one or more communications within a time interval of the at least one measurement of the set of CLI measurements is in accordance with the duplex capability.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports CLI measurement and communication scheduling for SBFD operation. The apparatus 900 may be a UE, or a UE may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 140). In some aspects, the communication manager 906 is the communication manager 150

In some aspects, the apparatus 900 may be configured to or operable to perform one or more operations described herein in connection with FIGS. 6A-6B. Additionally or alternatively, the apparatus 900 may be configured to or operable to perform one or more processes described herein, such as process 700 of FIG. 7 or process 1100 of FIG. 11, among other examples.

The reception component 902 may receive communications, such as reference signals, control information, or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the UE described above in connection with FIG. 1, such as a radio, one or more RF chains, one or more transceivers, or one or more modems, each of which may in turn be coupled with one or more antennas of the UE. In some aspects, the transmission component 904 may be co-located with the reception component 902.

The communication manager 906 may receive or may cause the reception component 902 to receive configuration information associated with a set of CLI measurements in a set of resources, wherein the set of resources includes a first resource for a first measurement of the set of CLI measurements and a second resource for a second measurement of the set of CLI measurements. The communication manager 906 may perform at least one measurement, of the set of CLI measurements, in accordance with a selection criterion for the set of CLI measurements. In some aspects, the communication manager 906 may perform one or more operations described elsewhere herein as being performed by one or more components of the communication manager 906.

In some aspects, the communication manager 906 includes a set of components, such as a measurement component 910. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 902 may receive configuration information associated with a set of CLI measurements in a set of resources, wherein the set of resources includes a first resource for a first measurement of the set of CLI measurements and a second resource for a second measurement of the set of CLI measurements. The measurement component 910 may perform at least one measurement, of the set of CLI measurements, in accordance with a selection criterion for the set of CLI measurements.

The transmission component 904 may transmit capability signaling identifying a capability for performing one or more of the set of CLI measurements. The reception component 902 may receive an indication of a selection of the at least one measurement of the set of CLI measurements in accordance with the capability signaling. The transmission component 904 may transmit signaling indicating whether one or more of the set of CLI measurements are associated with an uplink timing or a downlink timing. The transmission component 904 may transmit a capability indicator relating to a duplex capability for the set of CLI measurements.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports CLI measurement and communication scheduling for SBFD operation. The apparatus 1000 may be a network node, or a network node may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 145). In some aspects, the communication manager 1006 is the communication manager 155

In some aspects, the apparatus 1000 may be configured to or operable to perform one or more operations described herein in connection with FIGS. 6A-6B. Additionally or alternatively, the apparatus 1000 may be configured to or operable to perform one or more processes described herein, such as process 800 of FIG. 8 or process 1200 of FIG. 12, among other examples.

The reception component 1002 may receive communications, such as reference signals, control information, or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the network node described above in connection with FIG. 1, such as a radio, one or more RF chains, one or more transceivers, or one or more modems, each of which may in turn be coupled with one or more antennas of the network node.

The transmission component 1004 may transmit communications, such as reference signals, control information, or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node. In some aspects, the transmission component 1004 may be co-located with the reception component 1002.

The communication manager 1006 may transmit or may cause the transmission component 1004 to transmit configuration information associated with a set of CLI measurements in a set of resources, wherein the set of resources includes a first resource for a first measurement of the set of CLI measurements and a second resource for a second measurement of the set of CLI measurements. The communication manager 1006 may receive or may cause the reception component 1002 to receive a measurement report of at least one measurement, of the set of CLI measurements, in accordance with a selection criterion for the set of CLI measurements. In some aspects, the communication manager 1006 may perform one or more operations described elsewhere herein as being performed by one or more components of the communication manager 1006.

In some aspects, the communication manager 1006 includes a set of components, such as a configuration component 1010. Alternatively, the set of components may be separate and distinct from the communication manager 1006. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1004 may transmit configuration information associated with a set of CLI measurements in a set of resources, wherein the set of resources includes a first resource for a first measurement of the set of CLI measurements and a second resource for a second measurement of the set of CLI measurements. The reception component 1002 may receive a measurement report of at least one measurement, of the set of CLI measurements, in accordance with a selection criterion for the set of CLI measurements. The configuration component 1010 may configure one or more CLI measurements for a UE.

The reception component 1002 may receive capability signaling identifying a capability for performing one or more of the set of CLI measurements. The transmission component 1004 may transmit an indication of a selection of the at least one measurement of the set of CLI measurements in accordance with the capability signaling. The reception component 1002 may receive signaling indicating whether one or more of the set of CLI measurements are associated with an uplink timing or a downlink timing. The reception component 1002 may receive a capability indicator relating to a duplex capability for the set of CLI measurements.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a flowchart illustrating an example process 1100 performed, for example, at a UE or an apparatus of a UE that supports CLI measurement and communication scheduling for SBFD operation. Example process 1100 is an example where the apparatus or the UE (for example, UE 120) performs operations associated with CLI measurement and communication scheduling for SBFD operation.

As shown in FIG. 11, in some aspects, process 1100 may include wirelessly receiving configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band (block 1110). For example, the UE (such as by using the reception component 902, depicted in FIG. 9) may wirelessly receive configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band, as described above. In some aspects, the same resource may be the same slot, the same OFDM symbol, the same time resources, in resources overlapping in time, or another overlap that can result in a collision between communications.

As further shown in FIG. 11, in some aspects, process 1100 may include wirelessly performing one of the first measurement or the second measurement, in a symbol, in accordance with a collision handling rule, wherein whether reception of data in the symbol, concurrent with the first measurement or the second measurement, occurs is in accordance with a UE capability (block 1120). For example, the UE (such as by using the measurement component 910, depicted in FIG. 9) may wirelessly perform one of the first measurement or the second measurement, in a symbol, in accordance with a collision handling rule, wherein whether reception of data in the symbol, concurrent with the first measurement or the second measurement, occurs is in accordance with a UE capability, as described above. In some aspects, in situations where there is a potential collision between concurrent reception of data within the downlink sub-band and performance of a second measurement within the same downlink sub-band, the UE may determine whether such concurrent operations are supported based on an indicated UE capability. If the UE capability indicates a lack of support for concurrent reception and measurement, a collision handling rule may be applied to prioritize either data reception or the measurement, as specified by a network configuration. This approach ensures that the UE and the network node can reliably manage resource conflicts and maintain synchronization regarding UE behavior in such scenarios.

Process 1100 may include additional aspects, such as any single aspect or any combination of aspects described below or in connection with one or more other processes described elsewhere herein.

In a first additional aspect, process 1100 includes wirelessly receiving the data in the symbol, concurrent with the first measurement or the second measurement, in accordance with the UE capability. In this way, a network node can efficiently coordinate resource allocation and measurement scheduling based on the actual capabilities of the UE, thereby minimizing scheduling conflicts and optimizing overall system performance.

In a second additional aspect, alone or in combination with the first aspect, process 1100 includes wirelessly transmitting a capability indication of whether concurrent reception of a downlink signal in the downlink sub-band and performance of the first measurement in the uplink sub-band is supported, wherein the first measurement is a reference signal received power or a received signal strength indicator. In this way, a network node can determine whether to schedule concurrent downlink reception and uplink measurement operations for the UE, thereby improving resource utilization and ensuring reliable measurement performance based on the UE’s actual capabilities.

In a third additional aspect, alone or in combination with one or more of the first and second aspects, a capability indication indicates a lack of a capability for concurrent reception and transmission, and wherein, in accordance with the collision handling rule, the second measurement is prioritized over transmission of a physical uplink control channel, a physical uplink shared channel, or a sounding reference signal. In this way, the UE ensures that measurement operations are reliably performed by prioritizing the second measurement over uplink transmissions when concurrent reception and transmission are not supported by the UE.

In a fourth additional aspect, alone or in combination with one or more of the first through third aspects, a capability indication indicates a lack of a capability for concurrent reception and transmission, and wherein, in accordance with the collision handling rule, the first measurement is prioritized over reception of a physical downlink control channel, a physical downlink shared channel, a tracking channel state information reference signal, or a channel quality indicator channel state information reference signal. In this way, the UE ensures that measurement operations are given precedence over downlink receptions when the UE does not support concurrent reception and transmission, thereby maintaining the accuracy and reliability of measurement procedures.

In a fifth additional aspect, alone or in combination with one or more of the first through fourth aspects, the first measurement is consecutive with a synchronization signal block based measurement or a channel state information reference signal based measurement, such that there is no gap between the first measurement and the synchronization signal block based measurement or the channel state information based measurement. In this way, measurement efficiency is improved by eliminating unnecessary gaps between consecutive measurements, allowing for more timely and accurate acquisition of measurement data.

In a sixth additional aspect, alone or in combination with one or more of the first through fifth aspects, the configuration information includes an indication of a selection of the first measurement or the second measurement. In this way, a network node can explicitly control which measurement is performed, reducing ambiguity and ensuring that measurement operations align with network requirements and priorities. In some aspects, the collision handling rule may be to follow the indication of the selection of the first measurement or the second measurement.

In a seventh additional aspect, alone or in combination with one or more of the first through sixth aspects, the selection is applicable to a plurality of measurement opportunities. In this way, consistent measurement behavior is maintained across multiple measurement opportunities, enhancing reliability and simplifying network coordination.

In an eighth additional aspect, alone or in combination with one or more of the first through seventh aspects, at least a portion of the configuration information is received in connection with a measurement resource configuration message. In this way, the UE can promptly and accurately apply updated measurement configurations, supporting dynamic adaptation to changing network conditions.

In a ninth additional aspect, alone or in combination with one or more of the first through eighth aspects, process 1100 includes wirelessly transmitting capability signaling identifying a capability for performing one or more of the set of CLI measurements, and wirelessly receive an indication of a selection of the first measurement or the second measurement in accordance with the capability signaling. In this way, a network node can tailor measurement selection based on the specific capabilities reported by the UE, ensuring that measurement procedures are both compatible with the UE and optimized for network performance. In some aspects, the collision handling rule may be to follow the indication of the selection of the first measurement or the second measurement.

In a tenth additional aspect, alone or in combination with one or more of the first through ninth aspects, the configuration information includes an indication of a timing configuration for the first measurement or the second measurement. In this way, precise timing of measurement operations can be achieved, reducing the risk of conflicts and enhancing the accuracy of measurement results.

In an eleventh additional aspect, alone or in combination with one or more of the first through tenth aspects, a timing configuration for the first measurement or the second measurement is in accordance with a stored configuration. In this way, measurement operations can be consistently aligned with previously established configurations, supporting predictable and reliable measurement behavior.

In a twelfth additional aspect, alone or in combination with one or more of the first through eleventh aspects, a scheduling of the reception of the data is in accordance with a timing of the first measurement or the second measurement. In this way, data reception can be efficiently coordinated with measurement timing, minimizing interference and ensuring the integrity of both measurement and data operations.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, at a network node or an apparatus of a network node that supports CLI measurement and communication scheduling for SBFD operation. Example process 1200 is an example where the apparatus or the network node (for example, network node 110) performs operations associated with CLI measurement and communication scheduling for SBFD operation.

As shown in FIG. 12, in some aspects, process 1200 may include wirelessly transmitting configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band (block 1210). For example, the network node (such as by using the transmission component 1004, depicted in FIG. 10) may wirelessly transmit configuration information associated with a set of CLI measurements in a set of SBFD resources, wherein a first measurement, of the set of CLI measurements, is in a first resource in a slot in an uplink sub-band, and a second measurement, of the set of CLI measurements, is in the same resource in a downlink sub-band, as described above.

As further shown in FIG. 12, in some aspects, process 1200 may include wirelessly receiving a measurement report of the first measurement or the second measurement, in a symbol, in accordance with a collision handling rule, wherein whether transmission of data in the symbol, concurrent with the first measurement or the second measurement, occurs is in accordance with a user equipment capability (block 1220). For example, the network node (such as by using the reception component 1002, depicted in FIG. 10) may wirelessly receive a measurement report of the first measurement or the second measurement, in a symbol, in accordance with a collision handling rule, wherein whether transmission of data in the symbol, concurrent with the first measurement or the second measurement, occurs is in accordance with a user equipment capability, as described above.

Process 1200 may include additional aspects, such as any single aspect or any combination of aspects described below or in connection with one or more other processes described elsewhere herein.

In a first additional aspect, process 1200 includes wirelessly transmitting the data in the symbol, concurrent with the first measurement or the second measurement, in accordance with the UE capability. In this way, the network node can efficiently coordinate resource allocation and measurement scheduling based on the actual capabilities of the UE, thereby minimizing scheduling conflicts and optimizing overall system performance.

In a second additional aspect, alone or in combination with the first aspect, process 1200 includes wirelessly receiving a capability indication of whether concurrent reception of a downlink signal in the downlink sub-band and performance of the first measurement in the uplink sub-band is supported, wherein the first measurement is a reference signal received power or a received signal strength indicator. In this way, the network node can determine whether to schedule concurrent downlink reception and uplink measurement operations for the UE, thereby improving resource utilization and ensuring reliable measurement performance based on the UE’s actual capabilities.

In a third additional aspect, alone or in combination with one or more of the first and second aspects, a capability indication indicates a lack of a capability for concurrent reception and transmission, and wherein, in accordance with the collision handling rule, the second measurement is prioritized over transmission of a physical uplink control channel, a physical uplink shared channel, or a sounding reference signal. In this way, the UE ensures that measurement operations are reliably performed by prioritizing the second measurement over uplink transmissions when concurrent reception and transmission are not supported by the UE.

In a fourth additional aspect, alone or in combination with one or more of the first through third aspects, a capability indication indicates a lack of a capability for concurrent reception and transmission, and wherein, in accordance with the collision handling rule, the first measurement is prioritized over reception of a physical downlink control channel, a physical downlink shared channel, a tracking channel state information reference signal, or a channel quality indicator channel state information reference signal. In this way, the UE ensures that measurement operations are given precedence over downlink receptions when the UE does not support concurrent reception and transmission, thereby maintaining the accuracy and reliability of measurement procedures.

In a fifth additional aspect, alone or in combination with one or more of the first through fourth aspects, the first measurement is consecutive with a synchronization signal block based measurement or a channel state information reference signal based measurement, such that there is no gap between the first measurement and the synchronization signal block based measurement or the channel state information based measurement. In this way, measurement efficiency is improved by eliminating unnecessary gaps between consecutive measurements, allowing for more timely and accurate acquisition of measurement data.

In a sixth additional aspect, alone or in combination with one or more of the first through fifth aspects, the configuration information includes an indication of a selection of the first measurement or the second measurement. In this way, the network node can explicitly control which measurement is performed, reducing ambiguity and ensuring that measurement operations align with network requirements and priorities.

In a seventh additional aspect, alone or in combination with one or more of the first through sixth aspects, the selection is applicable to a plurality of measurement opportunities. In this way, consistent measurement behavior is maintained across multiple measurement opportunities, enhancing reliability and simplifying network coordination.

In an eighth additional aspect, alone or in combination with one or more of the first through seventh aspects, at least a portion of the configuration information is transmitted in connection with a measurement resource configuration message. In this way, the UE can promptly and accurately apply updated measurement configurations, supporting dynamic adaptation to changing network conditions.

In a ninth additional aspect, alone or in combination with one or more of the first through eighth aspects, process 1200 includes wirelessly receiving capability signaling identifying a capability for performing one or more of the set of CLI measurements, and wirelessly transmit an indication of a selection of the first measurement or the second measurement in accordance with the capability signaling. In this way, the network node can tailor measurement selection based on the specific capabilities reported by the UE, ensuring that measurement procedures are both compatible with the UE and optimized for network performance.

In a tenth additional aspect, alone or in combination with one or more of the first through ninth aspects, process 1200 includes wirelessly receiving signaling indicating whether the first measurement or the second measurement is in accordance with an uplink timing or a downlink timing. In this way, precise timing of measurement operations can be achieved, reducing the risk of conflicts and enhancing the accuracy of measurement results.

In an eleventh additional aspect, alone or in combination with one or more of the first through tenth aspects, the configuration information includes an indication of a timing configuration for the first measurement or the second measurement. In this way, measurement operations can be consistently aligned with previously established configurations, supporting predictable and reliable measurement behavior.

In a twelfth additional aspect, alone or in combination with one or more of the first through eleventh aspects, a timing configuration for the first measurement or the second measurement is in accordance with a stored configuration. In this way, data reception can be efficiently coordinated with measurement timing, minimizing interference and ensuring the integrity of both measurement and data operations.

In a thirteenth additional aspect, alone or in combination with one or more of the first through twelfth aspects, a scheduling the transmission of the data is in accordance with a timing of the first measurement or the second measurement. In this way, data transmission can be scheduled to avoid conflicts with measurement operations, thereby maintaining the accuracy of measurements and the reliability of data delivery.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

The following provides an overview of some Aspects of the present disclosure:

Aspect 1: A method of wireless communication by a user equipment (UE), comprising: receiving configuration information associated with a set of cross-link interference (CLI) measurements in a set of resources, wherein the set of resources includes a first resource for a first measurement of the set of CLI measurements and a second resource for a second measurement of the set of CLI measurements; and performing at least one measurement, of the set of CLI measurements, in accordance with a selection criterion for the set of CLI measurements.

Aspect 2: The method of Aspect 1, wherein the configuration information includes an indication of a selection of the at least one measurement of the set of CLI measurements.

Aspect 3: The method of any of Aspects 1-2, wherein the selection criterion includes a collision handling rule.

Aspect 4: The method of any of Aspects 1-3, wherein the selection criterion is in accordance with a stored configuration.

Aspect 5: The method of any of Aspects 1-4, wherein the configuration information includes an indication of a selection of the at least one measurement, and wherein the indication is applicable to a plurality of measurement opportunities.

Aspect 6: The method of any of Aspects 1-5, wherein at least a portion of the configuration information is received in connection with a measurement resource configuration message.

Aspect 7: The method of any of Aspects 1-6, comprising: transmitting capability signaling identifying a capability for performing one or more of the set of CLI measurements; and receiving an indication of a selection of the at least one measurement of the set of CLI measurements in accordance with the capability signaling.

Aspect 8: The method of any of Aspects 1-7, comprising: transmitting signaling indicating whether one or more of the set of CLI measurements are associated with an uplink timing or a downlink timing.

Aspect 9: The method of any of Aspects 1-8, wherein the configuration information includes an indication of a timing configuration for the at least one measurement of the set of CLI measurements.

Aspect 10: The method of any of Aspects 1-9, wherein a timing configuration for the at least one measurement of the set of CLI measurements is in accordance with a stored configuration.

Aspect 11: The method of any of Aspects 1-10, wherein a scheduling of one or more communications within a time interval of the at least one measurement of the set of CLI measurements is in accordance with a timing of the at least one measurement of the set of CLI measurements.

Aspect 12: The method of any of Aspects 1-11, comprising: transmitting a capability indicator relating to a duplex capability for the set of CLI measurements; and wherein a scheduling of one or more communications within a time interval of the at least one measurement of the set of CLI measurements is in accordance with the duplex capability.

Aspect 13: A method of wireless communication performed by a network node, comprising: transmitting configuration information associated with a set of cross-link interference (CLI) measurements in a set of resources, wherein the set of resources includes a first resource for a first measurement of the set of CLI measurements and a second resource for a second measurement of the set of CLI measurements; and receiving a measurement report of at least one measurement, of the set of CLI measurements, in accordance with a selection criterion for the set of CLI measurements.

Aspect 14: The method of Aspect 13, wherein the configuration information includes an indication of a selection of the at least one measurement of the set of CLI measurements.

Aspect 15: The method of any of Aspects 13-14, wherein the selection criterion includes a collision handling rule.

Aspect 16: The method of any of Aspects 13-15, wherein the selection criterion is in accordance with a stored configuration.

Aspect 17: The method of any of Aspects 13-16, wherein the configuration information includes an indication of a selection of the at least one measurement, and wherein the indication is applicable to a plurality of measurement opportunities.

Aspect 18: The method of any of Aspects 13-17, wherein at least a portion of the configuration information is received in connection with a measurement resource configuration message.

Aspect 19: The method of any of Aspects 13-18, comprising: receiving capability signaling identifying a capability for performing one or more of the set of CLI measurements; and transmitting an indication of a selection of the at least one measurement of the set of CLI measurements in accordance with the capability signaling.

Aspect 20: The method of any of Aspects 13-19, comprising: receiving signaling indicating whether one or more of the set of CLI measurements are associated with an uplink timing or a downlink timing.

Aspect 21: The method of any of Aspects 13-20, wherein the configuration information includes an indication of a timing configuration for the at least one measurement of the set of CLI measurements.

Aspect 22: The method of any of Aspects 13-21, wherein a timing configuration for the at least one measurement of the set of CLI measurements is in accordance with a stored configuration.

Aspect 23: The method of any of Aspects 13-22, wherein a scheduling of one or more communications within a time interval of the at least one measurement of the set of CLI measurements is in accordance with a timing of the at least one measurement of the set of CLI measurements.

Aspect 24: The method of any of Aspects 13-23, comprising: receiving a capability indicator relating to a duplex capability for the set of CLI measurements; and wherein a scheduling of one or more communications within a time interval of the at least one measurement of the set of CLI measurements is in accordance with the duplex capability.

Aspect 25: A method of wireless communication performed by a user equipment (UE), comprising: wirelessly receiving configuration information associated with a set of cross-link interference (CLI) measurements in a set of sub-band full-duplex (SBFD) resources, wherein a first measurement, of the set of CLI measurements, is in a first resource in a slot in an uplink sub-band, and a second measurement, of the set of CLI measurements, is in the same resource in a downlink sub-band; and wirelessly performing one of the first measurement or the second measurement, in a symbol, in accordance with a collision handling rule, wherein whether reception of data in the symbol, concurrent with the first measurement or the second measurement, occurs is in accordance with a UE capability.

Aspect 26: The method of Aspect 25, further comprising: wirelessly receiving the data in the symbol, concurrent with the first measurement or the second measurement, in accordance with the UE capability.

Aspect 27: The method of any of Aspects 25-26, further comprising: wirelessly transmitting a capability indication of whether concurrent reception of a downlink signal in the downlink sub-band and performance of the first measurement in the uplink sub-band is supported, wherein the first measurement is a reference signal received power or a received signal strength indicator.

Aspect 28: The method of any of Aspects 25-27, wherein a capability indication indicates a lack of a capability for concurrent reception and transmission, and wherein, in accordance with the collision handling rule, the second measurement is prioritized over transmission of a physical uplink control channel, a physical uplink shared channel, or a sounding reference signal.

Aspect 29: The method of any of Aspects 25-28, wherein a capability indication indicates a lack of a capability for concurrent reception and transmission, and wherein, in accordance with the collision handling rule, the first measurement is prioritized over reception of a physical downlink control channel, a physical downlink shared channel, a tracking channel state information reference signal, or a channel quality indicator channel state information reference signal.

Aspect 30: The method of any of Aspects 25-29, wherein the first measurement is consecutive with a synchronization signal block based measurement or a channel state information reference signal based measurement, such that there is no gap between the first measurement and the synchronization signal block based measurement or the channel state information based measurement.

Aspect 31: The method of any of Aspects 25-30, wherein the configuration information includes an indication of a selection of the first measurement or the second measurement.

Aspect 32: The method of Aspect 31, wherein the selection is applicable to a plurality of measurement opportunities.

Aspect 33: The method of any of Aspects 25-32, wherein at least a portion of the configuration information is received in connection with a measurement resource configuration message.

Aspect 34: The method of any of Aspects 25-33, further comprising: wirelessly transmitting capability signaling identifying a capability for performing one or more of the set of CLI measurements; and wirelessly receiving an indication of a selection of the first measurement or the second measurement in accordance with the capability signaling.

Aspect 35: The method of any of Aspects 25-34, wherein the configuration information includes an indication of a timing configuration for the first measurement or the second measurement.

Aspect 36: The method of any of Aspects 25-35, wherein a timing configuration for the first measurement or the second measurement is in accordance with a stored configuration.

Aspect 37: The method of any of Aspects 25-36, wherein a scheduling of the reception of the data is in accordance with a timing of the first measurement or the second measurement.

Aspect 38: A method of wireless communication performed by a network node, comprising: wirelessly transmitting configuration information associated with a set of cross-link interference (CLI) measurements in a set of sub-band full-duplex (SBFD) resources, wherein a first measurement, of the set of CLI measurements, is in a first resource in a slot in an uplink sub-band, and a second measurement, of the set of CLI measurements, is in the same resource in a downlink sub-band; and wirelessly receiving a measurement report of the first measurement or the second measurement, in a symbol, in accordance with a collision handling rule, wherein whether transmission of data in the symbol, concurrent with the first measurement or the second measurement, occurs is in accordance with a user equipment capability.

Aspect 39: The method of Aspect 38, further comprising: wirelessly transmitting the data in the symbol, concurrent with the first measurement or the second measurement, in accordance with the user equipment capability.

Aspect 40: The method of any of Aspects 38-39, further comprising: wirelessly receive a capability indication of whether concurrent reception of a downlink signal in the downlink sub-band and performance of the first measurement in the uplink sub-band is supported, wherein the first measurement is a reference signal received power or a received signal strength indicator.

Aspect 41: The method of any of Aspects 38-40, wherein a capability indication indicates a lack of a capability for concurrent reception and transmission, and wherein, in accordance with the collision handling rule, the second measurement is prioritized over transmission of a physical uplink control channel, a physical uplink shared channel, or a sounding reference signal.

Aspect 42: The method of any of Aspects 38-41, wherein a capability indication indicates a lack of a capability for concurrent reception and transmission, and wherein, in accordance with the collision handling rule, the first measurement is prioritized over reception of a physical downlink control channel, a physical downlink shared channel, a tracking channel state information reference signal, or a channel quality indicator channel state information reference signal.

Aspect 43: The method of any of Aspects 38-42, wherein the first measurement is consecutive with a synchronization signal block based measurement or a channel state information reference signal based measurement, such that there is no gap between the first measurement and the synchronization signal block based measurement or the channel state information based measurement.

Aspect 44: The method of any of Aspects 38-43, wherein the configuration information includes an indication of a selection of the first measurement or the second measurement.

Aspect 45: The method of Aspect 44, wherein the selection is applicable to a plurality of measurement opportunities.

Aspect 46: The method of any of Aspects 38-45, wherein at least a portion of the configuration information is transmitted in connection with a measurement resource configuration message.

Aspect 47: The method of any of Aspects 38-46, further comprising: wirelessly receiving capability signaling identifying a capability for performing one or more of the set of CLI measurements; and wirelessly transmit an indication of a selection of the first measurement or the second measurement in accordance with the capability signaling.

Aspect 48: The method of any of Aspects 38-47, further comprising: wirelessly receive signaling indicating whether the first measurement or the second measurement is in accordance with an uplink timing or a downlink timing.

Aspect 49: The method of any of Aspects 38-48, wherein the configuration information includes an indication of a timing configuration for the first measurement or the second measurement.

Aspect 50: The method of any of Aspects 38-49, wherein a timing configuration for the first measurement or the second measurement is in accordance with a stored configuration.

Aspect 51: The method of any of aspects 38-50, wherein a scheduling the transmission of the data is in accordance with a timing of the first measurement or the second measurement.

Aspect 52: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-51.

Aspect 53: An apparatus for wireless communication at a device, the apparatus comprising one or more memories and one or more processors coupled to the one or more memories, the one or more processors configured to cause the device to perform the method of one or more of Aspects 1-51.

Aspect 54: An apparatus for wireless communication, the apparatus comprising at least one means for performing the method of one or more of Aspects 1-51.

Aspect 55: A non-transitory computer-readable medium storing code for wireless communication, the code comprising instructions executable by one or more processors to perform the method of one or more of Aspects 1-51.

Aspect 56: A non-transitory computer-readable medium storing a set of instructions for wireless communication, the set of instructions comprising one or more instructions that, when executed by one or more processors of a device, cause the device to perform the method of one or more of Aspects 1-51.

Aspect 57: A device for wireless communication, the device comprising a processing system that includes one or more processors and one or more memories coupled with the one or more processors, the processing system configured to cause the device to perform the method of one or more of Aspects 1-51.

Aspect 58: An apparatus for wireless communication at a device, the apparatus comprising one or more memories and one or more processors coupled to the one or more memories, the one or more processors individually or collectively configured to cause the device to perform the method of one or more of Aspects 1-51.

Aspect 59: A device comprising one or more antennas, and a processing system that includes one or more processors and one or more memories that store code and are coupled with the one or more processors, the processing system configured to cause the device to perform the method of one or more of Aspects 1-51.

Aspect 60: A device comprising one or more antennas, and a processing system that includes processor circuitry and memory circuitry that stores code, the processing system configured to cause the device to perform the method of one or more of Aspects 1-51.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more antennas; and
a processing system that includes processor circuitry and memory circuitry that stores code, the processing system configured to cause the UE to:
wirelessly receive configuration information associated with a set of cross-link interference (CLI) measurements in a set of sub-band full-duplex (SBFD) resources, wherein a first measurement, of the set of CLI measurements, is in a first resource in a slot in an uplink sub-band, and a second measurement, of the set of CLI measurements, is in the same resource in a downlink sub-band; and
wirelessly perform one of the first measurement or the second measurement, in a symbol, in accordance with a collision handling rule, wherein whether reception of data in the symbol, concurrent with the first measurement or the second measurement, occurs is in accordance with a UE capability.

2. The UE of claim 1, wherein the processing system is configured to cause the UE to:
wirelessly receive the data in the symbol, concurrent with the first measurement or the second measurement, in accordance with the UE capability.

3. The UE of claim 1, wherein the processing system is configured to cause the UE to:
wirelessly transmit a capability indication of whether concurrent reception of a downlink signal in the downlink sub-band and performance of the first measurement in the uplink sub-band is supported, wherein the first measurement is a reference signal received power or a received signal strength indicator.

4. The UE of claim 1, wherein a capability indication indicates a lack of a capability for concurrent reception and transmission, and wherein, in accordance with the collision handling rule, the second measurement is prioritized over transmission of a physical uplink control channel, a physical uplink shared channel, or a sounding reference signal.

5. The UE of claim 1, wherein a capability indication indicates a lack of a capability for concurrent reception and transmission, and wherein, in accordance with the collision handling rule, the first measurement is prioritized over reception of a physical downlink control channel, a physical downlink shared channel, a tracking channel state information reference signal, or a channel quality indicator channel state information reference signal.

6. The UE of claim 1, wherein the first measurement is consecutive with a synchronization signal block based measurement or a channel state information reference signal based measurement, such that there is no gap between the first measurement and the synchronization signal block based measurement or the channel state information reference signal based measurement.

7. The UE of claim 1, wherein the configuration information includes an indication of a selection of the first measurement or the second measurement.

8. The UE of claim 7, wherein the selection is applicable to a plurality of measurement opportunities.

9. The UE of claim 1, wherein at least a portion of the configuration information is received in connection with a measurement resource configuration message.

10. The UE of claim 1, wherein the processing system is configured to cause the UE to:
wirelessly transmit capability signaling identifying a capability for performing one or more of the set of CLI measurements; and
wirelessly receive an indication of a selection of the first measurement or the second measurement in accordance with the capability signaling.

11. The UE of claim 1, wherein the configuration information includes an indication of a timing configuration for the first measurement or the second measurement.

12. The UE of claim 1, wherein a timing configuration for the first measurement or the second measurement is in accordance with a stored configuration.

13. The UE of claim 1, wherein a scheduling of the reception of the data is in accordance with a timing of the first measurement or the second measurement.

14. A network node, comprising:
one or more antennas; and
a processing system that includes processor circuitry and memory circuitry that stores code, the processing system configured to cause the network node to:
wirelessly transmit configuration information associated with a set of cross-link interference (CLI) measurements in a set of sub-band full-duplex (SBFD) resources, wherein a first measurement, of the set of CLI measurements, is in a first resource in a slot in an uplink sub-band, and a second measurement, of the set of CLI measurements, is in the same resource in a downlink sub-band; and
wirelessly receive a measurement report of the first measurement or the second measurement, in a symbol, in accordance with a collision handling rule, wherein whether transmission of data in the symbol, concurrent with the first measurement or the second measurement, occurs is in accordance with a user equipment capability.

15. The network node of claim 14, wherein the processing system is configured to cause the network node to:
wirelessly transmit the data in the symbol, concurrent with the first measurement or the second measurement, in accordance with the user equipment capability.

16. The network node of claim 14, wherein the processing system is configured to cause the network node to:
wirelessly receive a capability indication of whether concurrent reception of a downlink signal in the downlink sub-band and performance of the first measurement in the uplink sub-band is supported, wherein the first measurement is a reference signal received power or a received signal strength indicator.

17. The network node of claim 14, wherein a capability indication indicates a lack of a capability for concurrent reception and transmission, and wherein, in accordance with the collision handling rule, the second measurement is prioritized over transmission of a physical uplink control channel, a physical uplink shared channel, or a sounding reference signal.

18. The network node of claim 14, wherein a capability indication indicates a lack of a capability for concurrent reception and transmission, and wherein, in accordance with the collision handling rule, the first measurement is prioritized over reception of a physical downlink control channel, a physical downlink shared channel, a tracking channel state information reference signal, or a channel quality indicator channel state information reference signal.

19. The network node of claim 14, wherein the first measurement is consecutive with a synchronization signal block based measurement or a channel state information reference signal based measurement, such that there is no gap between the first measurement and the synchronization signal block based measurement or the channel state information reference signal based measurement.

20. The network node of claim 14, wherein the configuration information includes an indication of a selection of the first measurement or the second measurement.

21. The network node of claim 20, wherein the selection is applicable to a plurality of measurement opportunities.

22. The network node of claim 14, wherein at least a portion of the configuration information is transmitted in connection with a measurement resource configuration message.

23. The network node of claim 14, wherein the processing system is configured to cause the network node to:
wirelessly receive capability signaling identifying a capability for performing one or more of the set of CLI measurements; and
wirelessly transmit an indication of a selection of the first measurement or the second measurement in accordance with the capability signaling.

24. The network node of claim 14, wherein the processing system is configured to cause the network node to:
wirelessly receive signaling indicating whether the first measurement or the second measurement is in accordance with an uplink timing or a downlink timing.

25. The network node of claim 14, wherein the configuration information includes an indication of a timing configuration for the first measurement or the second measurement.

26. The network node of claim 14, wherein a timing configuration for the first measurement or the second measurement is in accordance with a stored configuration.

27. The network node of claim 14, wherein a scheduling the transmission of the data is in accordance with a timing of the first measurement or the second measurement.

28. A method for wireless communication by a user equipment (UE), comprising:
wirelessly receiving configuration information associated with a set of cross-link interference (CLI) measurements in a set of sub-band full-duplex (SBFD) resources, wherein a first measurement, of the set of CLI measurements, is in a first resource in a slot in an uplink sub-band, and a second measurement, of the set of CLI measurements, is in the same resource in a downlink sub-band; and
wirelessly performing one of the first measurement or the second measurement, in a symbol, in accordance with a collision handling rule, wherein whether reception of data in the symbol, concurrent with the first measurement or the second measurement, occurs is in accordance with a UE capability.

29. The method of claim 28, further comprising:
wirelessly receiving the data in the symbol, concurrent with the first measurement or the second measurement, in accordance with the UE capability.

30. A method for wireless communication by a network node, comprising:
wirelessly transmitting configuration information associated with a set of cross-link interference (CLI) measurements in a set of sub-band full-duplex (SBFD) resources, wherein a first measurement, of the set of CLI measurements, is in a first resource in a slot in an uplink sub-band, and a second measurement, of the set of CLI measurements, is in the same resource in a downlink sub-band; and
wirelessly receiving a measurement report of the first measurement or the second measurement, in a symbol, in accordance with a collision handling rule, wherein whether transmission of data in the symbol, concurrent with the first measurement or the second measurement, occurs is in accordance with a user equipment capability.
